(19) United States
(12) Patent Application Publication
(10) Pub. No.: US 2026/0309851 A1
(43) Pub. Date: Oct. 8, 2026

(54) Detecting and evaluating LIDAR performance degradation

(71) Applicant: Innoviz Technologies Ltd., Rosh HaAyin (IL)

(72) Inventors: Ronen Eshel, Herzliya (IL); Nir Goren, Herut (IL)

(21) Appl. No.: 19/482,751

(22) PCT Filed: May 13, 2024
(86) PCT No.: PCT/IL2024/050460

§ 371 Date: Nov. 9, 2025

Related U.S. Application Data
(60) Provisional application No. 63/502,100, filed on May 14, 2023.
(60) Provisional application No. 63/503,479, filed on May 21, 2023.

(51) Int. Cl. G01S 7/497; G01S 7/48; G01S 17/86; G01S 17/931; G01S 17/95

(52) U.S. Cl. CPC G01S 7/497; G01S 7/4802; G01S 17/86; G01S 17/931; G01S 17/95; G01S 2007/4977

(57) ABSTRACT

A LIDAR system, comprising one or more light sources configured to project light toward a field of view (FOV) of the LIDAR system, one or more sensors configured to receive light projected by the light source(s) and reflected from objects in the FOV, and one or more processors. The processor(s) are configured to cause the light source(s) to project light towards the FOV in a plurality of scanning cycles, receive from the sensor(s) reflection signals indicative of at least part of the projected light reflected from object(s) in the FOV, identify volumetrically dispersed targets indicative of at least one environmental condition in the FOV based on statistical analysis of data derived from reflection signals received during the plurality of scanning cycles, and transmitting one or more alerts indicative of presence of the environmental condition(s) to one or more systems associated with a vehicle on which the LIDAR system is mounted.

### TECHNICAL FIELD

The present disclosure relates to technology for scanning a surrounding environment, and, more specifically, but not exclusively, to using Light Detection and Ranging (LIDAR) based systems for scanning a surrounding environment to detect objects in the environment.

### RELATED APPLICATIONS

The present application claims the benefit of priority of U.S. provisional patent application No. 63/502,100 filed on May 14, 2023, and of U.S. provisional patent application No. 63/503,479 filed on May 21, 2023, the content of each of which is incorporated herein by reference in its entirety.

### BACKGROUND

With the advent of driver assist systems and autonomous vehicles, automobiles need to be equipped with systems capable of reliably sensing and interpreting their surroundings, including identifying obstacles, hazards, objects, and other physical parameters that might impact navigation of the vehicle. To this end, various technologies have been suggested including, for example, Radio Detection and Ranging (RADAR), LIDAR, camera-based systems, and/or the like operating alone, in conjunctions and/or in a redundant manner.

A major challenge for Advanced Driver Assistance Systems (ADAS) and autonomous Vehicles (AV) systems is their ability to reliably, accurately and/or consistently determine the vehicle's surroundings across different environmental conditions including, for example, rain, snow, ice, hail, fog, smog, dust, insects, darkness, bright light, and/or the like.

LIDAR technology may operate well in such differing conditions, as it relies on mapping objects in the surrounding environment of the vehicle and measuring distances to the detected objects by actively projecting light, for example, laser (continuous and/or pulsed) to the surrounding environment of the vehicle and measuring light reflected from objects in the environment.

### SUMMARY

It is an object of the present disclosure to provide methods, systems and/or software program products for improving performance of LIDAR systems by detecting and assessing performance degradation of LIDAR systems, including degradation induced by adverse environmental conditions. This objective is achieved by the features of the independent claims. Further implementation forms are apparent from the dependent claims, the description, and the figures. It should be noted that multiple such implementation forms may be combined together to any single embodiment.

According to a first aspect of embodiments disclosed herein, there is provided a LIDAR system, comprising one or more light sources configured to project light toward a field of view of the LIDAR system, one or more sensors configured to receive light projected by the one or more light sources and reflected from one or more objects in the field of view, and one or more processors configured to: cause the one or more light sources to project light towards at least a portion of the field of view in a plurality of scanning cycles, receive from the one or more sensors reflection signals indicative of at least part of the projected light reflected from one or more objects in the at least a portion of the field of view, identify volumetrically dispersed targets in the least a portion of the field of view based on statistical analysis of data derived from the signals generated by the one or more sensors during the plurality of scanning cycles, the volumetrically dispersed targets are indicative of one or more environmental conditions, and transmit one or more alerts to one or more systems associated with a vehicle on which the LIDAR system is mounted, the alert is indicative of the presence of the one or more environmental conditions.

According to a second aspect of embodiments disclosed herein, there is provided a method of detecting environmental conditions based on statistical analysis of data captured by a LIDAR system, comprising causing one or more light sources of a lidar system to project light towards at least a portion of a field of view of the lidar system in a plurality of scanning cycles, receiving, from one or more sensors of the lidar system, reflection signals indicative of at least part of the projected light reflected from one or more objects in the at least a portion of the field of view, identifying volumetrically dispersed targets in the least a portion of the field of view based on statistical analysis of data derived from the received signals generated by the one or more sensors during the plurality of scanning cycles, the volumetrically dispersed targets are indicative of one or more environmental condition, and transmitting one or more alerts to one or more systems associated with a vehicle on which the LIDAR system is mounted. The one or more alerts are indicative of the presence of the one or more environmental conditions.

In a further implementation form of the first and/or second aspects optionally together with one or more of their related implementation forms, the one or more environmental conditions are members of a group consisting of: ice, snow, rain, hail, dust, and/or fog.

In a further implementation form of the first and/or second aspects optionally together with one or more of their related implementation forms, the statistical analysis indicative of one or more characteristics of the one or more environmental conditions. The one or more characteristics are members of a group consisting of: a precipitation density, a particulate density, and/or an average particulate size.

In a further implementation form of the first and/or second aspects optionally together with one or more of their related implementation forms, the statistical analysis comprises determining a variation in an observed level of one or more detection parameters of the LIDAR system induced by one or more characteristics of the one or more environmental conditions. The one or more detection parameters are members of a group consisting of: a reflectivity level of one or more object identified in the at least a portion of the field of view, a detection range, a false detection rate, and/or a confidence level of detection.

In a further implementation form of the first and/or second aspects optionally together with one or more of their related implementation forms, the statistical analysis further comprises determining the variation in the observed level of the one or more detection parameters in combination with a distance between the LIDAR system and the one or more identified objects to identify a dependency indicative of the one or more environmental conditions.

In a further implementation form of the first and/or second aspects optionally together with one or more of their related implementation forms, the statistical analysis comprises determining one or more changes in a noise baseline over a range of distances relative to the LIDAR system, the one or more changes in the noise baseline is indicative of one or more volumetric reflection conditions induced by the one or more environmental conditions.

In a further implementation form of the first and/or second aspects optionally together with one or more of their related implementation forms, the statistical analysis comprises computing one or more light reflection distribution patterns indicative of one or more volumetric reflection conditions induced by the one or more environmental conditions.

In an optional implementation form of the first and/or second aspects optionally together with one or more of their related implementation forms, a statistical analysis is applied to analyze data extracted from a point cloud created based on the reflection signals to identify one or more points having no neighbor points and thus potentially indicative of the one or more environmental conditions.

In an optional implementation form of the first and/or second aspects optionally together with one or more of their related implementation forms, a magnitude of impairment of one or more operational capabilities of the LIDAR system is estimated based on the statistical analysis. The one or more operational capabilities are members of a group consisting of: a detection range, and/or a certainty of a determined distance to one or more objects identified in the at least a portion of the field of view.

In an optional implementation form of the first and/or second aspects optionally together with one or more of their related implementation forms, an expected magnitude of impairment of one or more operational capabilities of the LIDAR system is estimated based on the statistical analysis.

In a further implementation form of the first and/or second aspects optionally together with one or more of their related implementation forms, the expected magnitude of impairment of the one or more operational capabilities is predicted based on analysis of information derived from the data compared with reference information retrieved from one or more lookup tables.

In a further implementation form of the first and/or second aspects optionally together with one or more of their related implementation forms, the expected magnitude of impairment of the one or more operational capabilities are predicted using one or more machine learning models trained to estimate magnitude of impairment of the one or more operational capabilities. The one or more machine learning models are trained using a training dataset comprising light reflection distribution patterns indicative of light reflection by the volumetrically dispersed targets.

In an optional implementation form of the first and/or second aspects optionally together with one or more of their related implementation forms, an expected fall of one or more of the operational capabilities below a predetermined performance threshold is predicted based on the statistical analysis.

In an optional implementation form of the first and/or second aspects optionally together with one or more of their related implementation forms, an amount of time until one or more of the operational capabilities are expected to fall below the predetermined performance threshold is predicted based on the statistical analysis.

In an optional implementation form of the first and/or second aspects optionally together with one or more of their related implementation forms, the one or more environmental conditions are identified based on the statistical analysis combined with sensory data captured by one or more external sensors associated with a vehicle on which the LIDAR system is mounted. The one or more external sensors are members of a group consisting of: an external light source, an ambient light sensor, and/or a precipitation sensor.

In an optional implementation form of the first and/or second aspects optionally together with one or more of their related implementation forms, one or more of the environmental conditions and/or an impact of the one or more environmental conditions on performance of the LIDAR system is identified based on the statistical analysis combined with data associated with a location of a vehicle on which the LIDAR system is mounted. Wherein the location of the vehicle is derived from one or more of: a navigation system of the vehicle, and/or a map database. The data associated with the location of the vehicle is received from one or more remote systems.

In an optional implementation form of the first and/or second aspects optionally together with one or more of their related implementation forms, presence of one or more blocking agent on a window associated with the LIDAR system is identified based on the statistical analysis. The blocking agents is a member of a group consisting of: ice, water droplets, smog, spray, dust, pollen, insects, mud, and/or bird droppings.

In an optional implementation form of the first and/or second aspects optionally together with one or more of their related implementation forms, an amount of time until the one or more operational capability is expected to fall below the predetermined performance threshold based on an accumulation rate of the one or more blocking agent on the window predicted based on the statistical analysis.

In a further implementation form of the first and/or second aspects optionally together with one or more of their related implementation forms, the one or more processors are further configured to adjust the one or more alert to include one or more recommended operational restrictions for a vehicle on which the LIDAR system is mounted.

According to a third aspect of embodiments disclosed herein, there is provided a LIDAR system, comprising one or more light sources configured to project light toward a field of view of the LIDAR system, one or more sensors configured to receive light projected by the one or more light sources and reflected from one or more objects in the field of view, and one or more processors configured to cause the one or more light sources to project light towards the at least a portion of the field of view, receive from the one or more sensors reflection signals indicative of at least part of the projected light reflected from one or more reference objects identified in the at least a portion of the field of view. compute, based on the reflection signals, a value of one or more LIDAR performance indicator parameters of the LIDAR system, compare between the computed value and a corresponding reference value of the one or more LIDAR performance indicator parameters with respect to the one or more reference objects, determine a performance level of the LIDAR system based on the comparison, and transmit the determined performance level to one or more systems associated with a vehicle on which the LIDAR system is mounted.

According to a fourth aspect of embodiments disclosed herein, there is provided a method of determining a performance level of LIDAR systems based on reference objects detected in an environment of the LIDAR systems, comprising causing one or more light sources of a LIDAR system to project light towards at least a portion of a field of view of the LIDAR system, receiving, from one or more sensors of the LIDAR system, reflection signals indicative of at least part of the projected light reflected from one or more reference objects identified in the at least a portion of the field of view, computing, based on the reflection signals, a measured value of one or more LIDAR performance indicator parameters relating to one or more operational capabilities of the LIDAR system, comparing between the measured value and a corresponding reference value of the one or more LIDAR performance indicator parameters with respect to the one or more reference objects, determine a performance level of the LIDAR system based on the comparison, and transmitting the determined performance level to one or more systems associated with a vehicle on which the LIDAR system is mounted.

In a further implementation form of the third and/or fourth aspects optionally together with one or more of their related implementation forms, the reference value of the one or more LIDAR performance indicator parameters comprises a predefined value retrieved from one or more storage, the one or more storage is a member of a group consisting of: a local storage of the LIDAR system, and one or more remote server.

In a further implementation form of the third and/or fourth aspects optionally together with one or more of their related implementation forms, the reference value of the one or more LIDAR performance indicator parameter is determined based on aggregation of a plurality of crowdsourced measurements of the one or more LIDAR performance indicator parameters computed by a plurality of LIDAR systems with respect to the one or more reference objects.

In a further implementation form of the third and/or fourth aspects optionally together with one or more of their related implementation forms, the aggregation comprises an average value associated with one or more LIDAR interaction properties of the plurality of LIDAR systems with the one or more reference objects, and/or a standard deviation associated with the one or more LIDAR interaction properties.

In a further implementation form of the third and/or fourth aspects optionally together with one or more of their related implementation forms, the one or more LIDAR interaction properties are updated based on aggregation of a plurality of crowdsourced measurements captured with respect to the one or more reference objects by a plurality of LIDAR systems over time.

In a further implementation form of the third and/or fourth aspects optionally together with one or more of their related implementation forms, the reference value of the one or more LIDAR performance indicator parameters is received via wireless communication from one or more another LIDAR systems in the vicinity.

In a further implementation form of the third and/or fourth aspects optionally together with one or more of their related implementation forms, the one or more LIDAR performance indicator parameters relate to one or more operational capabilities of the LIDAR system. The one or more operational capabilities are members of a group consisting of: a detection range, a reflectivity level associated with the one or more reference object, a detection confidence level, a signal to noise ratio, a noise level, a false detection rate, and/or a distance of first-detection.

In a further implementation form of the third and/or fourth aspects optionally together with one or more of their related implementation forms, the false detection rate is determined based on emissions detected by the LIDAR system while directed toward the sky.

In a further implementation form of the third and/or fourth aspects optionally together with one or more of their related implementation forms, the value of the one or more LIDAR performance indicator parameters is evaluated with respect to one or more characteristics of the one or more reference objects. The one or more characteristics are members of a group consisting of: a reflectivity level, a size, and/or a shape.

In a further implementation form of the third and/or fourth aspects optionally together with one or more of their related implementation forms, the one or more reference objects comprise one or more custom and/or dedicated reference reflectors identified in an environment of the LIDAR system.

In a further implementation form of the third and/or fourth aspects optionally together with one or more of their related implementation forms, the one or more reference objects comprise one or more blooming reference objects consisting of one or more regions of high reflectivity surrounded by a region of low reflectivity.

In a further implementation form of the third and/or fourth aspects optionally together with one or more of their related implementation forms, the reflectivity level of the one or more reference objects is characterized by spatially varying reflectivity. Wherein the one or more processors is configured to adjust the computed value of the one or more LIDAR performance indicator parameters based on reflection signals relating to the spatially varying reflectivity.

In a further implementation form of the third and/or fourth aspects optionally together with one or more of their related implementation forms, the one or more reference objects comprises one or more active reference light sources emitting light detected by the one or more sensor. The one or more active reference light sources are members of a group consisting of: a continuous wave light source, a pulsing light source, and/or a reactive light source.

In a further implementation form of the third and/or fourth aspects optionally together with one or more of their related implementation forms, the reactive light source is configured to emit light responsive to illumination from the LIDAR system.

In a further implementation form of the third and/or fourth aspects optionally together with one or more of their related implementation forms, the one or more reference objects are identified by analyzing a point cloud generated for the at least a portion of the field of view based on reflection signals received from the one or more sensors which are indicative of at least part of the projected light reflected from objects in the least a portion of the field of view.

In a further implementation form of the third and/or fourth aspects optionally together with one or more of their related implementation forms, the one or more processors are configured to identify the one or more reference objects based on localization information of the one or more reference objects with respect to the LIDAR system. Wherein the localization information is determined based on data received from one or more localization sensors associated with the LIDAR system, and/or based on data retrieved from one or more remote servers.

In a further implementation form of the third and/or fourth aspects optionally together with one or more of their related implementation forms, the one or more processors are further configured to determine a state of one or more operational capabilities of the LIDAR system. The state is a member of a group consisting of: the one or more operational capability is within a predetermined normal operating range, the one or more operational capability fell below a predetermined threshold, and/or a magnitude by which the one or more operational capability of the LIDAR system fell below the predetermined threshold.

In a further implementation form of the third and/or fourth aspects optionally together with one or more of their related implementation forms, the changes in the one or more operational capabilities are tracked overtime.

In a further implementation form of the third and/or fourth aspects optionally together with one or more of their related implementation forms, the one or more processors are further configured to detect a rate of decline in a performance level associated with the one or more operational capabilities based on the tracked changes.

In a further implementation form of the third and/or fourth aspects optionally together with one or more of their related implementation forms, the one or more processors are further configured to predict a time at which the performance level associated with the one or more operational capabilities is expected to cross a predetermined threshold.

In a further implementation form of the third and/or fourth aspects optionally together with one or more of their related implementation forms, the one or more processors are further configured to determine an operational status of the LIDAR system based on the comparison. The operational status is a member of a group consisting of: a blockage of a window associated with the LIDAR system, a malfunction associated with the one or more sensor, and/or an environmental condition present in the environment of the LIDAR system.

In a further implementation form of the third and/or fourth aspects optionally together with one or more of their related implementation forms, the one or more processors are further configured to identify a presence of one or more environmental conditions based on the comparison between the computed value and the reference value of the one or more LIDAR performance indicator parameters. The one or more environmental conditions are members of a group consisting of: ice, snow, rain, hail, fog, smog, dust, insects, and/or bright light.

Consistent with other disclosed embodiments, non-transitory computer-readable storage media may store program instructions, which are executed by at least one processor and perform any of the methods described herein.

The foregoing general description and the following detailed description are exemplary and explanatory only and are not restrictive of the claims.

### BRIEF DESCRIPTION OF THE DRAWINGS

The accompanying drawings, which are incorporated in and constitute a part of this disclosure, illustrate various disclosed embodiments by way of example only. With specific reference now to the drawings in detail, it is stressed that the particulars are shown by way of example and for purposes of illustrative discussion of embodiments disclosed herein. In this regard, the description taken with the drawings makes apparent to those skilled in the art how disclosed embodiments may be practiced.

The accompanying drawings, which are incorporated in and constitute a part of this disclosure, illustrate various disclosed embodiments.

In the drawings:

FIG. 1A and FIG. 1B are schematic illustrations of an exemplary LIDAR system, in accordance with embodiments of the present disclosure;

FIG. 2 illustrates graph charts of exemplary light emission patterns projected by a LIDAR system, in accordance with embodiments of the present disclosure;

FIG. 3 is a flow chart of an exemplary process of detecting environmental conditions based on a statistical analysis of data generated by a LIDAR system, in accordance with embodiments of the present disclosure;

FIG. 4 depicts graph charts illustrating detection of noise relating to ambient light captured by a LIDAR system, in accordance with embodiments of the present disclosure;

FIG. 5A and FIG. 5B are graph charts illustrating standard deviation of noise captured by a LIDAR system with respect to range (distance), in accordance with embodiment of the present disclosure;

FIG. 6 are graph charts illustrating exemplary light reflection patterns, detected based on analysis of a point cloud created based on data captured by a LIDAR system, indicative of environmental conditions, in accordance with embodiments of the present disclosure;

FIG. 7 is a flow chart of an exemplary process of determining performance level of a LIDAR system based on reference objects identified in the environment of the LIDAR system, in accordance with embodiments of the present disclosure;

FIG. 8 is a schematic illustration of an exemplary system for determining performance level of a LIDAR system based on reference objects identified in the environment of the LIDAR system, in accordance with embodiments of the present disclosure;

FIG. 9 illustrates exemplary reference objects having spatially varying reflectivity, in accordance with embodiments of the present disclosure; and

FIG. 10 is a schematic illustration of an exemplary system for updating values of LIDAR performance indicator parameters of LIDAR systems based on crowdsourced measurements computed by a plurality of LIDAR systems for reference objects, in accordance with embodiments of the present disclosure.

### DETAILED DESCRIPTION

The present disclosure relates to LIDAR technology for scanning a surrounding environment, and, more specifically, but not exclusively, to LIDAR systems employing active light signals projection for scanning a surrounding environment to detect objects in the surrounding environment.

LIDAR systems are often used for safety-critical applications such as, for example, ADAS, Autonomous Vehicles (AV), safety monitoring systems, and/or the like and as such must comply with safety-critical requirements as well as other regulatory requirements since failure in their operation may lead to severe injury, and death, as well as environmental harm, damage, and/or loss of property.

As such, safety standards, for example, automotive and/or autonomous driving regulations may dictate that a LIDAR system should constantly monitor its operational state and detection performance and provide information in case its performance is degraded in order to allow the safety-critical application, for example, an ADAS, an AV system, and/or the like to take one or more measures, operations, actions, and/or decisions to encounter, compensate and/or mitigate the performance degradation in the LIDAR system. For example, in response to a notification of performance degradation of the LIDAR system, the ADAS and/or AV system reduce vehicle's velocity, bring the vehicle to a stop, transfer control of the vehicle to a human operator, and/or the like.

There are many factors which may degrade and/or lead to degradation in the performance of LIDAR systems, for example, failure in one or more functional elements of the LIDAR system, adverse environmental conditions, ambient and/or background light, and more.

According to some embodiments of the present disclosure, there are provided methods, systems, devices, and computer software programs for automatically detecting one or more environmental conditions in the environment of the LIDAR system, for example, ice, snow, rain, hail, dust, sand, fog, and/or the like and estimate a degree and/or level of performance degradation of the LIDAR system due to the identified environmental conditions.

In particular, the environmental conditions and their impact on the LIDAR system may be identified, evaluated, estimated, and/or predicted based on based on one or more statistical analyses applied to identify one or more light reflection patterns typical to volumetrically dispersed targets, i.e., particulates, for example, particles, droplets, spray, vapors, and/or the like associated with the environmental conditions. Such volumetrically dispersed targets, typically having a size which is substantially the same or smaller than the light beams projected by the LIDAR system, may exhibit light scattering behavior and patterns, for example, light attenuation, retroreflection, and/or the like which may be identified over time.

The statistical analysis may be therefore applied to analyze data generated based on a plurality of light samples captured by the LIDAR system sensor(s) to identify light scattering patterns indicative of the light attenuation and/or scattering behavior of the volumetrically dispersed targets. In particular, the statistical analysis may be therefore applied to analyze data generated by the LIDAR system sensor(s) over time in a plurality of scanning cycles during which the LIDAR system projects light to illuminate a scene in at least part of its FOV and light reflected from objects in the scene may be received and captured by the sensor(s).

The generated data may comprise raw sample data, for example, reflection signals (trace data) generated by the sensor(s) which are indicative of the light received and captured by the sensor(s) over a time period. The time period may correlate with the time associated with a single pixel. In another example, the generated data may comprise higher level data generated based on the trace data, for example, one or more three dimensional (3D) models, for example, a point cloud, a polygon mesh, a depth image holding depth information for each pixel of a two dimensional (2D) image and/or array, and/or any other type of 3D model of the scene.

The statistical analysis may employ one or more statistical techniques, methods, and/or algorithms, for example, to identify variation in reflectivity levels of objects identified in the scene, variation in detection range of objects identified in the scene, variation in a noise baseline and/or the like which may identify, reveal and/or indicate of one or more of the light scattering and/or light reflection patterns typical to the volumetrically dispersed targets associated with one or more of the environmental conditions.

Optionally, the statistical analysis may be applied to the generated data after noise relating to ambient light is filtered out of the data.

Moreover, based on the statistical analysis, an impact and/or effect of the volumetrically dispersed targets on the performance of the LIDAR system may be evaluated to estimate and/or determine a performance degradation of the LIDAR system, for example, determine a magnitude of impairment of one or more operational capabilities of the LIDAR system, for example, a detection range, a detection resolution, an effective extent of the LIDAR system's FOV, a certainty (confidence level) of a determined distance to one or more objects identified in the FOV, and/or the like.

Furthermore, a future performance degradation of the LIDAR system may be predicted based on the statistical analysis using, for example, previous information and/or reflection patterns identified in the past by the statistical analysis associated with measured, and/or simulated magnitudes of impairment of one or more of the LIDAR system's operational capabilities. In another example, the future performance degradation of the LIDAR system may be predicted using one or more Machine Learning (ML) models trained to estimate the magnitude of impairment of one or more of the operational capabilities based on data received from the statistical analysis.

Optionally, an expected fall of one or more of the operational capabilities below one or more predetermined threshold levels and a time period (time duration, amount of time) until the expected fall may be also predicted, estimated, and/or determined based on the statistical analysis.

Optionally, the environmental conditions may be identified and their adverse performance impact on the LIDAR estimated, and/or predicted based on the statistical analysis in conjunction (in combination) with additional data received from one or more external sources other the LIDAR system, for example, one or more sensors (e.g., ambient light sensor, humidity sensor, precipitation sensor, etc.), weather information, weather forecast, and/or the like.
an expected fall of one or more of the operational capabilities below one or more predetermined threshold levels and a time period (amount of time) until the expected fall may be also predicted, estimated, and/or determined based on the statistical analysis.

One or more alerts may be generated to indicate the environmental condition(s) identified in the environment of the LIDAR system. Optionally one or more of the alert(s) may be further indicative of the degree of adverse performance induced by the identified environmental condition(s), for example, the magnitude of impairment of the operational capability(s), the predicted future predicted magnitude of impairment, the expected drop below the threshold, the time period until the expected drop, and/or the like.

Using the statistical analysis to identify environmental condition(s) identified in the environment of LIDAR systems and estimate the degree of the adverse performance impact of the environmental conditions on the LIDAR systems may present major benefits and advantages over currently existing LIDAR systems.

First, identifying and reporting performance degradation of LIDAR systems in general and due to environmental conditions in particular may significantly increase safety of passengers in the vehicle as well as in its surrounding environment since safety critical applications relying on the LIDAR systems may be aware of this performance degradation and may take measures to overcome this limitation, for example, use one or more other detection systems which may be less susceptible to the impact of the identified environmental conditions, apply redundancy between multiple detection systems, transfer to at least partial manual control, and/or the like.

Moreover, determining and reporting the level of performance degradation of the LIDAR system, for example, the magnitude of impairment of operational functionalities of the LIDAR system may enable the safety critical applications to more accurately, reliably, and/or robustly select and/or evaluate the countermeasures taken to compensate and/or mitigate the loss of performance in the LIDAR system according to the exact degradation level.

Furthermore, predicting future degree of adverse performance impact induced by the environmental conditions may enable the safety critical applications to prepare in advance and select and/or evaluate accordingly a wider, more suitable and/or more passenger friendly (e.g., reduced abrupt braking sharp turns, etc.) range of countermeasures to mitigate the loss of performance in the LIDAR system. For example, assuming a LIDAR system mounted on an autonomous vehicle driving on a high-speed highway reports a gradually decreasing degradation in its performance which is predicted to fall below a certain threshold in a few minutes. In such case, the safety critical application, for example, an AV system, may start looking for a suitable, and/or appropriate location to stop the vehicle without disturbing traffic and/or safe for the passengers in the vehicle.

In addition, determining a current and/or predicting a future level of performance degradation of LIDAR due to the environmental conditions based on the statistical analysis combined with data received from external sources may increase accuracy, reliability, and/or consistency of the detection, determination, and/or prediction of the adverse performance impact thus allowing the safety critical systems to take more countermeasures that may better address the environmental conditions.

According to some embodiments disclosed herein, performance of the LIDAR system may be evaluated, estimated, and/or otherwise determined using one or more reference objects identified in the environment of the LIDAR system. In particular, LIDAR performance indicator parameters relating to one or more of the LIDAR system's operational capabilities may be computed with respect to one or more of the reference objects and compared with corresponding reference values relating to the same reference objects which reflect normal operation and/or performance of the LIDAR system. Based on the comparison, a performance level and moreover a magnitude of impairment of one or more of the operational capabilities may be identified and/or determined.

The reference values which are considered ground truth values of the LIDAR performance indicator parameters may comprise, for example, values measured and/or simulated for one or more of the reference objects. In another example, the reference values of one or more of the LIDAR performance indicator parameters may comprise crowdsourced reference values computed and/or established based on values measured and/or computed by a plurality of LIDAR systems with respect to one or more of the reference objects. In particular, the values of the LIDAR performance indicator parameters measured by the plurality of LIDAR systems with respect to a certain reference object may be aggregated to produce an aggregated value, for example, an average, a standard deviation, and/or the like which may be used as a reference value.

Optionally, the reference values may be updated over time to adjust to changes in one or more characteristics of one or more of the reference objects, for example, a reflectivity level, and/or the like which may change and/or vary over time.

Evaluating and determining performance of LIDAR systems based on their detection of reference objects associated with known LIDAR performance indicator parameters may present major benefits and advantages over currently existing LIDAR systems.

First, identifying and reporting performance level, and specifically performance degradation of LIDAR systems in may significantly increase safety of passengers in the vehicle as well as safety in the vehicle's environment since safety critical applications relying on the LIDAR systems may be aware of the performance degradation and may take measures to overcome, and/or mitigate this limitation, for example, use one or more other detection systems which may be less susceptible to the impact of the identified environmental conditions, apply redundancy between multiple detection systems, transfer to at least partial manual control, and/or the like.

Moreover, determining the level of performance of the LIDAR system based on comparison between measured values of the LIDAR performance indicator parameters and known, validated, reference LIDAR performance indicator parameters values which are significantly accurate and specific to each reference object may significantly increase accuracy of the evaluated performance level.

Furthermore, creating, and/or establishing the reference values of the LIDAR performance indicator parameters based on aggregated crowdsourced values aggregating values measured by a plurality of LIDAR systems may significantly reduce complexity, resources, cost, and/or effort since such measurements are constantly made by the LIDAR systems with respect to a plurality of objects identified in their environment and are thus readily available in abundance.

In addition, using crowdsourced reference values may significantly increase accuracy, reliability, and/or robustness of the reference values since they may be monitored over time and updated accordingly thus adjusting to possible changes, alterations, and/or variations in reflection characteristics of the reference objects. For example, slow changes over time (e.g., over the course of several weeks, months or years) in the values of the reference values of the LIDAR performance indicator parameters may indicate degradation of the LIDAR device, or degradation of one or more characteristics of the reference object, whereas fast changes (e.g., over the course of several seconds, minutes, or hours) may indicate degradation of LIDAR performance due to external interference, for example due to impact of environmental conditions. Crowdsourcing may enable distinguishing between causes of slow changes. Also, since crowdsourced measurements made with respect to a plurality of objects identified in the LIDAR systems environment is highly available, practically any suitable object which is observable and identifiable in the LIDAR systems environment may be used thus eliminating the need to deploy dedicated reference objects which may reduce costs, effort, and/or complexity of deployment of the reference objects.

The following detailed description refers to the accompanying drawings. Wherever possible, the same reference numbers are used in the drawings and the following description to refer to the same or similar parts.

While illustrative embodiments are described herein, it is to be understood that these are not necessarily limited in their application to the details of construction and/or arrangement of the components, systems, or methods, since modifications, adaptations and other implementations are possible. For example, as may be appreciated by one skilled in the art, substitutions, additions, and/or modifications may be made to the components illustrated in the drawings, and the illustrative methods described herein may be modified by substituting, reordering, removing, or adding steps to the disclosed methods.

Accordingly, the following detailed description is not limited to the disclosed embodiments and examples. Instead, the proper scope is defined by the appended claims.

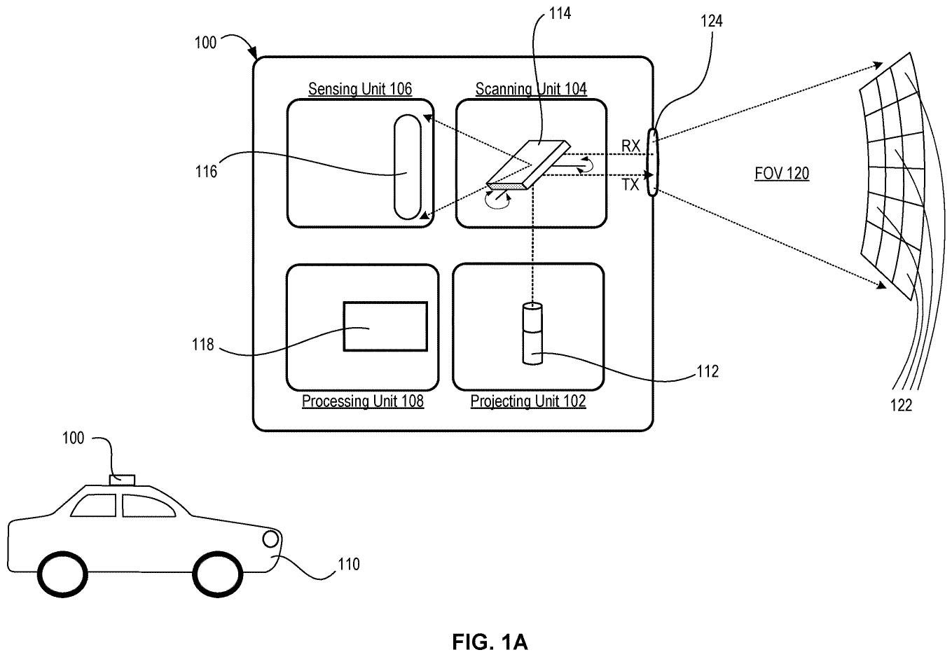

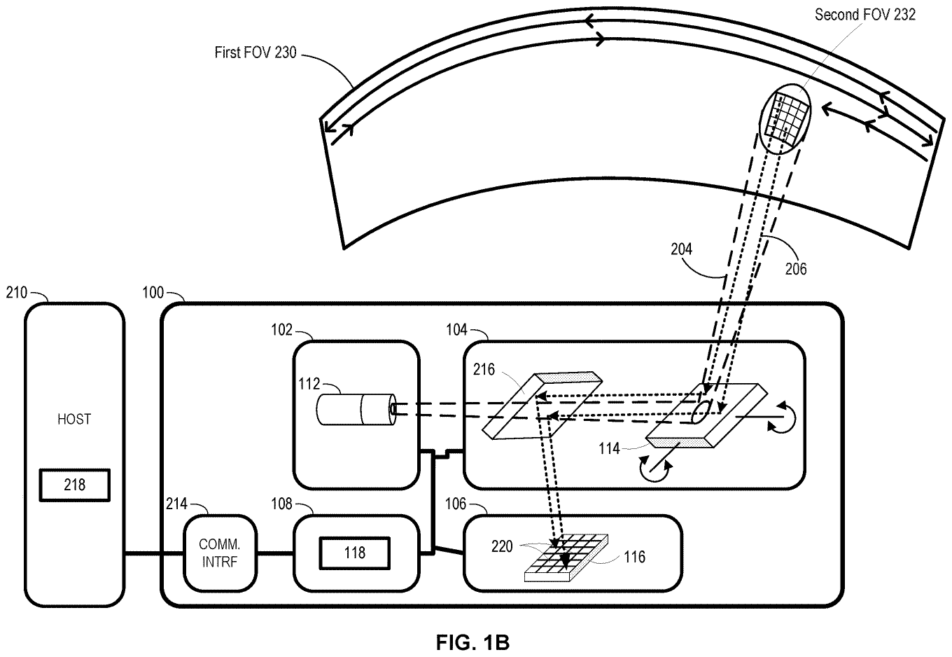

Referring now to the drawings, FIG. 1A and FIG. 1B illustrating an exemplary LIDAR system 100, in accordance with embodiments of the present disclosure. The LIDAR system 100 may be used, for example, in one or more ground autonomous or semi-autonomous vehicles 110, for example, road-vehicles such as, for example, cars, buses, vans, trucks and any other terrestrial vehicle. Autonomous ground vehicles 110 equipped with the LIDAR system 100 may scan their environment and drive to a destination vehicle with reduced and potentially without human intervention. In another example, the LIDAR system 100 may be used in one or more autonomous/semi-autonomous aerial-vehicles such as, for example, Unmanned Aerial Vehicles (UAV), drones, quadcopters, and/or any other airborne vehicle or device. In another example, the LIDAR system 100 may be used in one or more autonomous or semi-autonomous water vessels such as, for example, boats, ships, hovercrafts, submarines, and/or the like. Autonomous aerial-vehicles and watercrafts with LIDAR system 100 may scan their environment and navigate to a destination autonomously or under remote human operation.

It should be noted that the LIDAR system 100 or any of its components may be used together with any of the example embodiments and methods disclosed herein. Moreover, while aspects of the LIDAR system 100 may be described herein with respect to an exemplary vehicle-based LIDAR platform, the LIDAR system 100, any of its components, or any of the processes described herein may be applicable to one or more LIDAR systems of other platform types. As such, LIDAR systems such as the LIDAR system 100 may be installed, mounted, integrated, and/or otherwise deployed, in dynamic and/or stationary deployment for one or more other applications, for example, a surveillance system, a security system, a monitoring system, and/or the like. Such LIDAR systems 100 may be configured to scan their environment in order to detect objects according to their respective application needs, criteria, requirements, and/or definitions.

The LIDAR system 100 be configured to detect tangible objects in an environment of the LIDAR system 100, specifically in a scene contained in an FOV 120 of the LIDAR system 100 based on reflected light, and more specifically, based on light projected by the LIDAR system 100 and reflected by objects in the FOV 120. The scene may include some or all objects within the FOV 120, in their relative positions and in their current states, for example, ground elements (e.g., earth, roads, grass, sidewalks, road surface marking, etc.), sky, man-made objects (e.g., vehicles, buildings, signs, etc.), vegetation, people, animals, light projecting elements (e.g., flashlights, sun, other LIDAR systems, etc.), and/or the like. An object refers to a finite composition of matter that may reflect light from at least a portion thereof. An object may be at least partially solid (e.g., car, tree, etc.), at least partially liquid (e.g., puddles on a road, rain, etc.), at least partly gaseous (e.g., fumes, clouds, etc.), made of a multitude of distinct particles (e.g., sandstorm, fog, spray, etc.), and/or a combination thereof. An object may be of one or more scales of magnitude, such as, for example, ~1 millimeter (mm), ~5 mm, ~10 mm, ~50 mm, ~100 mm, ~500 mm, ~1 meter (m), ~5 m, ~10 m, ~50 m, ~100 m, and so on.

The LIDAR system 100 may be configured to detect objects by scanning the environment of the LIDAR system 100, i.e., illuminating at least part of the FOV 120 of the LIDAR system 100 and collecting and/or receiving light reflected from the illuminated part(s) of the FOV 120. The LIDAR system 100 may scan the FOV 120 and/or part thereof in a plurality of scanning cycles (frames) conducted at one or more frequencies and/or frame rates, for example, 5 Frames per Second (fps), 10 fps, 15 fps, 20 fps, and/or the like.

The LIDAR system 100 may apply one or more scanning mechanisms, methods, and/or implementations for scanning the environment. For example, the LIDAR system 100 may scan the environment by moving and/or pivoting one or more deflectors of the LIDAR system 100 to deflect light emitted from the LIDAR system 100 in differing directions toward different parts of the FOV 120. In another example, the LIDAR system 100 may scan the environment by changing positioning (i.e., location and/or orientation) of one or more sensor associated with the LIDAR system 100 with respect to the FOV 120. In another example, the LIDAR system 100 may scan the environment by changing positioning (i.e. location, and/or orientation) of one or more light sources associated with the LIDAR system 100 with respect to the FOV 120. In another example, the LIDAR system 100 may scan the environment by changing the positioning one or more sensor and one or more light sources associated with the LIDAR system 100 with respect to the FOV 120.

The FOV 120 scanned by the LIDAR system 100, i.e., the environment in which the LIDAR system 100 may detect objects, may include an extent of the observable environment of LIDAR system 100 in which objects may be detected. The extent of the FOV 120 may be defined by a horizontal range (e.g., 50°, 120°, 360°, etc.), and a vertical elevation (e.g., ±20°, +40°-20°, ±90°, 0°-90°, etc.). The FOV 120 may also be defined within a certain range, for example, up to a certain depth/distance (e.g., 100 m, 200 m, 300 m, etc.), and up to a certain vertical distance (e.g., 10 m, 25 m, 50 m, etc.).

The FOV 120 may be divided (segmented) into a plurality of portions 122 (segments), also designated FOV pixels, having uniform and/or different sizes. In some embodiments, as illustrated in FIG. 1A, the FOV 120 may be divided into a plurality of portions 122 arranged in the form of a two-dimensional array of rows and columns. At any given time during a scan of the FOV 120, the LIDAR system 100 may scan an instantaneous FOV which comprises a respective portion 122. Obviously, the portion 122 scanned during each instantaneous FOV may be narrower than the entire FOV 120, and the LIDAR system 100 may thus move the instantaneous FOV within the FOV 120 in order to scan the entire FOV 120.

Detecting an object may broadly refer to determining an existence of the object in the FOV 120 of the LIDAR system 100 which reflects light emitted by the LIDAR system 100 towards one or more sensors, interchangeably designated detectors, associated with the LIDAR system 100. Additionally, or alternatively, detecting an object may refer to determining one or more physical parameters relating to the object and generating information indicative of the determined physical parameters, for example, a distance between the object and one or more other objects (e.g., the LIDAR system 100, another object in the FOV 120, ground (earth), etc.), a kinematic parameter of the object (e.g., relative velocity, absolute velocity, movement direction, expansion of the object, etc.), a reflectivity (level) of the object, and/or the like.

The LIDAR system 100 may detect objects by processing detection results based on sensory data received from the sensor(s) which may comprise temporal information indicative of a period of time between the emission of a light signal by the light source(s) of the LIDAR system 100 and the time of detection of reflected light by the sensor(s) associated with the LIDAR system 100.

The LIDAR system 100 may employ one or more detection technologies. For example, the LIDAR system 100 may employ Time of Flight (ToF) detection where the light signal emitted by the LIDAR system 100 may comprise one or more short pulses, whose rise and/or fall time may be detected in reception of the emitted light after reflected by one or more objects in the FOV 120. In another example, the LIDAR system 100 may employ continuous wave detection, for example, Frequency Modulated Continuous Wave (FMCW), phase-shift continuous wave, and/or the like.

For various reasons, the LIDAR system 100 may detect only part of one or more objects present in the FOV 120. For example, light may be reflected from only some sides of an object, for example, typically only the side opposing the LIDAR system 200 may be detected by the LIDAR system 100. In another example, light emitted by the LIDAR system 100 may be projected on only part of an, for example, a laser beam projected onto a road or a building. In another example, an object may be partly blocked by another object between the LIDAR system 100 and the detected object. In another example, ambient light and/or one or more other interferences may interfere with detection of one or more portions of an object.

Optionally, detecting an object by the LIDAR system 100 may further refer to identifying the object, for example, classifying a type of the object (e.g., car, person, tree, road, traffic light, etc.), recognizing a specific object (e.g., natural site, structure, monument, etc.), determining a text value of the object (e.g., license plate number, road sign markings, etc.), determining a composition of the object (e.g., solid, liquid, transparent, semitransparent, etc.), and/or the like.

The LIDAR system 100 may comprise a projecting unit 102, a scanning unit 104, a sensing unit 106, and a processing unit 108. According to some embodiments, the LIDAR system 100 may be mountable on a vehicle 110.

Optionally, the LIDAR system 100 may include one or more optical windows 124 for transmitting outgoing light projected towards the FOV 120 and/or for receiving incoming light reflected from objects in field of view 120. The optical window(s) 124, for example, an opening, a flat window, a lens, or any other type of optical window may be used for one or more purposes, for example, collimating the projected light, focusing of the reflected light, and/or the like.

The LIDAR system 100 may be contained in a single housing and/or divided among a plurality of housings connected to each other via one or more communication channels, for example, a wired channel, fiber optics cable, and/or the like deployed between the first and second housings, a wireless connection (e.g., RF connection), fiber optics cable, and/or any combination thereof. For example, the light related components of the LIDAR system 100, i.e., the projecting unit 102, the scanning unit 104, and the sensing unit 106 may be deployed and/or contained in a first housing while the processing unit 108 may be deployed and/or contained in a second housing. In such case, the processing unit 108 may communicate with the projecting unit 102, the scanning unit 104, and/or the sensing unit 106 via the communication channel(s) connecting the separate housings for controlling of the scanning unit 104 and/or for receiving from the sensing unit 106 sensory information indicative of light reflected from the scanned scene.

The LIDAR system 100 may employ one or more designs architectures, and/or configurations for the optical path of outbound light (transmission path TX) projected by the projecting unit 102 towards the scene, i.e., to the FOV 120 of the LIDAR system 100, and of inbound light (reception path RX) reflected from objects in the scene and directed to the sensing unit 106. For example, the LIDAR system 100 may employ bi-static configuration in which the outbound light projected from the projecting unit 102 and exits the LIDAR system 100 and the inbound light reflected from the scene and entering the LIDAR system 100 pass through substantially different optical paths comprising optical components, for example, windows, apertures, lenses, mirrors, beam splitters, and/or the like. In another example, as shown in FIG. 1B, the LIDAR system 100 may employ monostatic configuration in which the outbound light and the inbound light share substantially the same optical path, i.e., the light 204 projected by the projecting unit 102 and exiting from the LIDAR system 100 and the light 206 reflected from the scene and entering the LIDAR system 100 pass through substantially similar optical paths and share most if not all of the optical components on the shared optical path.

The projecting unit 102 may include one or more light sources 112 configured to emit light in one or more light forms, for example, a laser diode, a solid-state laser, a high-power laser, an edge emitting laser, a Vertical-Cavity Surface-Emitting Laser (VCSEL), an External Cavity Diode Laser (ECDL), A distributed Bragg reflector (DBR) laser, a laser array, and/or the like.

The light source(s) 112 may be configured and/or operated, for example, by the processing unit 108, to emit light according to one or more light emission patterns defined by one or more light emission parameters, for example, lighting mode (e.g., pulsed, Continuous Wave (CW), quasi-CW, etc.), light format (e.g., angular dispersion, polarization, etc.), spectral range (wavelength), energy/power (e.g., average power, maximum power, power intensity, instantaneous power, etc.), timing (e.g., pulse width (duration), pulse repetition rate, pulse sequence, pulse duty cycle, etc.), and/or the like. Optionally, the projecting unit 102 may further comprise one or more optical elements associated with one or more of the light source(s) 112, for example, a lens, an aperture, a window, a light filter, a waveplate, a beam splitter, and/or the like for adjusting the light emitted by the light source(s) 112, or example, collimating, focusing, polarizing, and/or the like the emitted light beams.

The scanning unit 104 may be configured to illuminate the FOV 120 and/or part thereof with projected light 204 by projecting the light emitted from the light source(s) 112 toward the scene thus serving as a steering element on the outbound path, i.e., the transmission path TX, of the LIDAR system 100 for directing the light emitted by the light source(s) 112 toward the scene.

The scanning unit 104 may be further used on the inbound path of the LIDAR system 100, i.e., the reception path RX, for directing the light (photons) 206 reflected from one or more objects in at least part of the FOV 120 toward the sensing unit 106.

The scanning unit 104 may include one or more light deflectors 114 configured to deflect the light from the light source(s) 112 for scanning the FOV 120. The light deflector(s) 114 may include one or more scanning mechanism, module, devices, and/or elements configured to cause the emitted light to deviate from its original path, for example, a mirror, a prism, a controllable lens, a mechanical mirror, a mechanical scanning polygon, an active diffraction (e.g., controllable LCD), a Risley prisms, a non-mechanical-electro-optical beam steering (such as made, for example, by Vescent), a polarization grating (such as offered, for example, by Boulder Non-Linear Systems), an Optical Phase Array (OPA), and/or the like. For example, the deflector(s) 114 may comprise one or more scanning polygons, interchangeable designated polygon scanner, having a plurality of facets, for example, three, four, five, six and/or the like configured as mirrors and/or prisms to deflect light projected onto the facet(s) of the polygon. In another example, the deflector(s) 114 may comprise one or more Micro Electro-Mechanical Systems (MEMS) mirrors configured to move by actuation of a plurality of benders connected to the mirror. In another example, the scanning unit 104 may include one or more non-mechanical deflectors 114, for example, a non-mechanical-electro-optical beam steering such as, for example, an OPA which does not require any moving components or internal movements for changing the deflection angles of the light but is rather controlled by steering, through phase array means, a light projection angle of the light source(s) 112 to a desired projection angle. It is noted that any discussion relating to moving or pivoting the light deflector(s) 114 is also applicable, mutatis mutandis, to controlling any type of light deflector 114 such that it changes its deflection behavior.

At any given time, i.e., at any instantaneous point in time, during each scan cycle of the FOV 120 and/or part thereof, the deflector(s) 114 may be positioned in a respective instantaneous position defining a respective location, position and/or orientation in space. In particular, each instantaneous position of the deflector(s) 114 may correspond to a respective portion 122 of the FOV 120. This means that while positioned in each of a plurality of instantaneous positions during each scan cycle of the FOV 120 and/or part thereof, the deflector(s) 114 may scan a respective one of the plurality of portions 122 of the FOV 120, i.e., project light 204 towards the respective portion 122 and/or direct light (photons) reflected from the respective portion 122 towards the sensing unit 106.

The scanning unit 104 may be configured and/or operated to scan the FOV 120 and/or part thereof, on the outbound path and/or on the inbound path, at one or more scales of scanning. For example, the scanning unit 104 may be configured to scan the entire FOV 120. In another example the scanning unit 104 may be configured to scan one or more ROIs which cover 10% or 25% of the FOV 120. Optionally, the scanning unit 104 may dynamically adjust the scanning scale, i.e., the scanned area, either between different scanning cycles and/or during the same scanning cycle.

Optionally, the scanning unit 104 may further comprise one or more optical elements associated with the deflector(s) 114, for example, a lens, an aperture, a window, a light filter, a waveplate, a beam splitter, and/or the like for adjusting the light emitted by the light source(s) 112 and/or for adjusting the light reflected from the scene, for example, collimate the projected light 204, focus the reflected light 206, and/or the like.

The sensing unit 106 may include one or more sensors 116 configured to receive and sample light reflected from the surroundings of LIDAR system 100, specifically from the scene, i.e., the FOV 120, and generate reflection signals, interchangeably designated trace signals or trace data, indicative of light captured by the sensor(s) 116 which may include light reflected from one or more objects in the FOV 120. The sensor(s) 116 may include one or more devices, elements, and/or systems capable of measuring properties of electromagnetic waves, specifically light, for example, energy/power, intensity, frequency, phase, timing, duration, and/or the like and generate output signals indicative of the measured properties. The sensor(s) 116 may be configured and/or operated to sample incoming light according to one or more operation modes, for example, continuous sampling, periodic sampling, sampling according to one or more timing schemes, and/or sampling instructions.

The sensor(s) 116 may include one or more light sensors of one or more types having differing parameters, for example, sensitivity, size, recovery time, and/or the like. The sensor(s) 116 may include a plurality of light sensors of a single type, or of multiple types selected according to their characteristics to comply with one or more detection requirements of the LIDAR system 100, for example, reliable and/or accurate detection over a span of ranges (e.g., maximum range, close range, etc.), dynamic range, temporal response, robustness against varying environmental conditions (e.g., temperature, rain, illumination, etc.), and/or the like.

For example, as seen in FIG. 1B, the sensor(s) 116, for example, a Silicon Photomultipliers (SiPM), a non-silicon photomultipliers, and/or the like, may include one or more light detectors constructed from a plurality of detecting elements 220, for example, an Avalanche Photodiode (APD), Single Photon Avalanche Diode (SPAD), and/or the like serving as detection elements 220 on a common silicon substrate configured for detecting photons reflected back from the FOV 120. The detecting elements 220 of each sensor 116 may be typically arranged as an array in one or more arrangements over a detection area of the sensor 116, for example, a rectangular arrangement, for example, as shown in FIG. 1B, a square arrangement, an alternating rows arrangement, and/or the like. Optionally, the detecting elements 220 may be arranged in a plurality of regions which jointly cover the detection area of the sensor 116. Each of the plurality of regions may comprise a plurality of detecting elements 220, for example, SPADs having their outputs connected together to form a common output signal of the respective region.

Each of the light detection elements 220 is configured to cause an electric current to flow when light (photons) passes through an outer surface of the respective detection element 220.

The processing unit 108 may include one or more processors 118, homogenous or heterogeneous, comprising one or more processing nodes and/or cores optionally arranged for parallel processing, as clusters and/or as one or more multi core processor(s). The processor(s) 118 may execute one or more software modules such as, for example, a process, a script, an application, a (device) driver, an agent, a utility, a tool, an Operating System (OS), a plug-in, an add-on, and/or the like each comprising a plurality of program instructions stored in a non-transitory medium (program store) of the LIDAR system 100 and executed by one or more processors such as the processor(s) 118. The non-transitory medium may include, for example, persistent memory (e.g., ROM, Flash, SSD, NVRAM, etc.) volatile memory (e.g., RAM component, cache, etc.) and/or the like such as the storage 234 and executed by one or more processors such as the processor(s) 232. The processor(s) 118 may optionally integrate, utilize and/or facilitate one or more hardware elements (modules), for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU), an Artificial Intelligence (AI) accelerator and/or the like. The processor(s) 118 may therefore execute one or more functional modules implemented using one or more software modules, one or more of the hardware modules and/or combination thereof.

The processor(s) 118 may therefore execute one or more functional modules to control functionality of the LIDAR system 100, for example, configuration, operation, coordination, and/or the like of one or more of the functional elements of the LIDAR system 100, for example, the projecting unit 102, the scanning unit 104, and/or the sensing unit 106. While the functional module(s) are executed by the processor(s) 118, for brevity and clarity, the processing unit 108 comprising the processor(s) 118 is described hereinafter to control functionality of the LIDAR system 100.

The processing unit 108 may communicate with the functional elements of the LIDAR system 100 via one or more channels, interconnects, and/or networks deployed in the LIDAR system 100, for example, a bus (e.g., PCIe, etc.), a switch fabric, a network, a vehicle network, and/or the like.

For example, the processing unit 108 may control the scanning unit 104 to scan the environment of the LIDAR system 100 according to one or more scanning schemes and/or scanning parameters, for example, extent (e.g., angular extent) of the FOV 120, extent (e.g., angular extent) of one or more regions of interest (ROI) within the FOV 120, maximal range within the FOV 120, maximal range within each ROI, maximal range within each region of non-interest, resolution (e.g., vertical angular resolution, horizontal angular resolution, etc.) within the FOV 120, resolution within each ROI, resolution within each region of non-interest, scanning mode (e.g., raster, alternating pixels, etc.), scanning speed, scanning cycle timing (e.g., cycle time, frame rate), and/or the like.

In another example, the processor(s) 118 may be configured to coordinate operation of the light source(s) 112 with movement of the deflector(s) 114 for scanning the FOV 120 and/or part thereof. In another example, the processor(s) 118 may be configured to configure and/or operate the light source(s) 112 to project light according to one or more light emission patterns. In another example, the processor(s) 118 may be configured to coordinate operation of the sensor(s) 116 with movement of the deflector(s) 114 to activate one or more selected sensor(s) 116 and/or pixels according to the scanned portion of the FOV 120.

In another example, the processor(s) 118 may be configured to receive the reflection signals generated by the sensor(s) 116 which are indicative of light captured by the sensor(s) 116 which may include light reflected from the scene specifically light reflected from one or more objects in the scanned FOV 120 and/or part thereof. In another example, the processor(s) 118 may be configured to analyze the trace signals (reflection signals) received from the sensor(s) 116 in order to detect one or more objects, conditions, and/or the like in the environment of the LIDAR system 100, specifically in the scanned FOV 120 and/or part thereof. Analyzing the trace data indicative of the reflected light 206 may include, for example, determining a ToF of the reflected light 206, based on timing of outputs of reflection signals, specifically with respect to transmission timing of projected light 204, for example, light pulses, corresponding to the respective reflected light 206. In another example, analyzing the trace data may include determining a power of the reflected light, for example, average power across an entire return pulse, and a photon distribution/signal may be determined over the return pulse period (“pulse shape”).

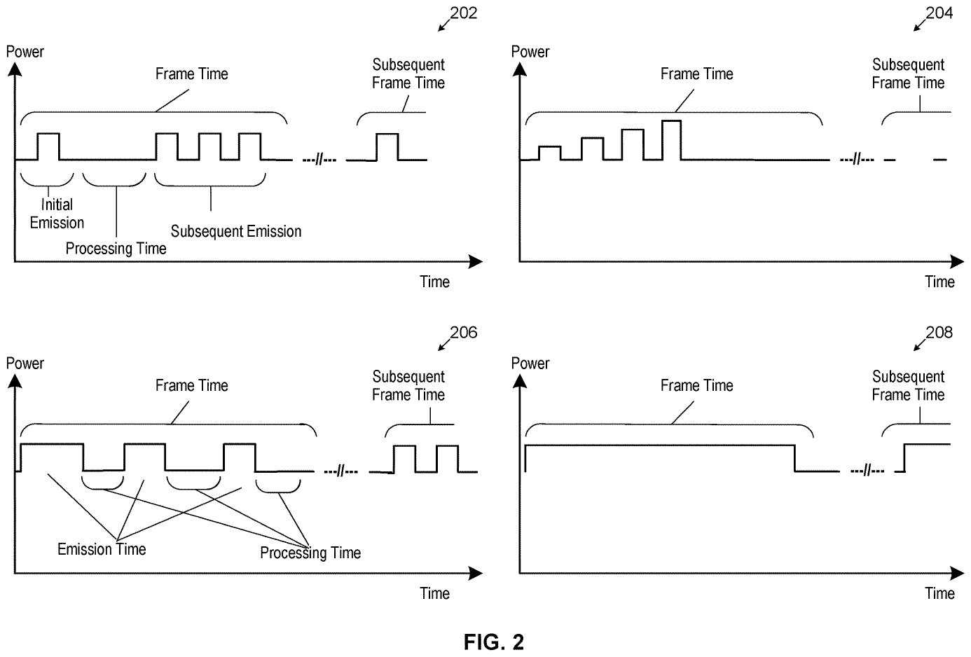

Reference is now made to FIG. 2, which illustrates graph charts of exemplary light emission patterns projected by a LIDAR system such as the LIDAR system 100, in accordance with embodiments of the present disclosure. Graph charts 202, 204, 206, and 208 depict several light emission patterns which may be emitted by one or more light sources such as the light source 112 of a projecting unit such as the projecting unit 102 of the LIDAR system 100. In particular, the light source(s) 112 may emit light according to the light patterns under control of a processing unit such as the processing unit 108 of the LIDAR system 100. The graph charts 202, 204, 206, and 208 expressing the light emission patterns of power (intensity) over time, illustrate emission patterns of light projected in a single frame (frame-time) for a single portion such as the portion 122 of an FOV such as the FOV 120 of the LIDAR system 100 which, as discussed herein before, is associated with an instantaneous position of one or more deflectors such as the deflector 114 of the LIDAR system 100.

As seen in graph chart 202, the processing unit 108 may control the light source(s) 112, for example, a pulsed-light light source, to project toward the portion 122 one or more initial pulses according to an initial light emission pattern, also designated pilot pulses. The processing unit 108 may analyze pilot information received from one or more sensors, such as the sensor 116 which is indicative of light reflections associated with the pilot pulses and, based on the analysis, may determine one or more light emission patterns according to which the light source(s) 122 may transmit subsequent light pulses during the frame time of the present frame and/or during one or more subsequent frames. As seen in graph chart 204, the processing unit 108 may control the light source(s) 112 to project toward the portion 122 light pulses according to a light emission pattern defining a plurality of pulses having gradually increasing intensities. As seen in graph chart 206, the processing unit 108 may control the light source(s) 112 to project toward the portion 122 light pulses according to different light emission patterns in different frames, i.e., in different scanning cycles, for example, a different number of pulses, pulses having different pulse duration, pulses having different intensity, and/or the like. As seen in graph chart 208, the processing unit 108 may control the light source(s) 112, for example, a continuous-wave light source (e.g., FMCW), to project toward the portion 122 light according to one or more light emission patterns. Such an exemplary light emission pattern may include, for example, projecting continuous light during the entire frame time. In another example, the light emission pattern may define one or more discontinuities, i.e., time periods during which the light source(s) 112 do not emit light. In another example, the light emission pattern may define emission of a continuous light having a constant intensity, or alternatively emission of a continuous light having varying intensity over time.

The processing unit 108 may be configured to analyze the trace data, i.e., the reflection signals received from the sensor(s) 116 which are indicative light reflected from the scene including at least part of the light emitted by the LIDAR system 100. Based on analysis of the trace data which the processing unit 108 may extract depth data relating to the scene, i.e., in the FOV 120 and/or part thereof and may derive and/or determine one or more attributes of one or more objects detected in the scene based on the light reflected from these objects. Such object attributes may include, for example, a distance between the LIDAR system 100 and the respective object from the LIDAR system 100, a reflectivity of the respective object, a spatial location of the respective object, for example, with respect to one or more coordinate systems (e.g., Cartesian (X, Y, Z), Polar (r, 0, b), etc.), and/or the like. Based on the trace data coupled with the scanning scheme of the scanning unit 104, i.e., the illuminated portion 122 of the FOV 120 to which the trace data relates, the processing unit 108 may therefore map the reflecting objects in the environment of the LIDAR system 100.

The processing unit 108 may combine, join, merge, fuse, and/or otherwise aggregate information, for example, depth data pertaining to different objects, and/or different features of objects detected in the scene. For example, the processing unit 108 may be configured to generate and/or reconstruct one or more 3D models, interchangeably designated depth maps herein, of the environment of the LIDAR system 100, i.e., of objects scanned in the scene included in the FOV 120 and/or part thereof. The data resolution associated with the depth map representation(s) of the FOV 120 which may depend on the operational parameters of the LIDAR system 100 may be defined by horizontal and/or vertical resolution, for example, 0.1°×0.1°, 0.3°×0.3°, 0.1°×0.5° of the FOV 120, and/or the like.

The processing unit 108 may generate depth map(s) of one or more forms, formats and/or types, for example, a point cloud model, a polygon mesh, a depth image holding depth information for each pixel of a 2D image and/or array, and/or any other type of 3D model of the scene. A point cloud model (also known a point cloud) may include a set of data points located spatially which represent the scanned scene in some coordinate system, i.e., having an identifiable locations in a space described by a coordinate system, for example, Cartesian, Polar, and/or the like. Each point in the point cloud may be a dimensionless, or a miniature cellular space whose location may be described by the point cloud model using the set of coordinates.

The point cloud may further include additional information for one or more and possibly all of its points, for example, reflectivity (e.g., energy of reflected light, etc.), color information, angle information, and/or the like. A polygon mesh or triangle mesh may include, among other data, a set of vertices, edges and faces that define the shape of one or more 3D objects (polyhedral object) detected in the scanned scene. The processing unit 108 may further generate a sequence of depth maps over time, i.e., a temporal sequence of depth maps, for example, each depth map in the sequence may be associated with a respective scanning cycle (frame). In another example, the processing unit 108 may update one or more depth maps over time based on depth data received and analyzed in each frame.

Optionally, the processing unit 108 may control the light projection scheme of the light emitted to the environment of the LIDAR system 100, for example, adapt, and/or adjust the light emission pattern and/or the scanning pattern, to improve mapping of the environment of the LIDAR system 100. For example, the processing unit 108 may control the light projection scheme such to illuminate differently different portions 122 across the FOV 120 in order to differentiate between reflected light relating to different portions 122. In another example, the processing unit 108 may apply a first light projection scheme for one or more first areas in the FOV 120, for example, an ROI and a second light projection scheme for one or more other parts of the FOV 120. In another example, the processing unit 108 may adjust the light projection scheme between scanning cycles (frames) such that a different light projection scheme may be applied in different frames. another example, the processing unit 108 may adjust the light projection scheme based on detection of reflected light, either during the same scanning cycle (e.g., the initial emission) and/or between different frames (e.g., successive frames), thus making the LIDAR system 100 extremely dynamic.

Optionally, the LIDAR system 100 may include a communication interface 214 comprising one or more wired and/or wireless communication channels and/or network links, for example, PCIe, Local Area Network (LAN), Gigabit Multimedia Serial Link (GMSL), vehicle network, InfiniBand, wireless LAN (WLAN), cellular network, and/or the like. Via the communication interface 214, the LIDAR system 100, specifically the processing unit 108 may transfer data and/or communicate with one or more external systems, for example, a host system 210, interchangeable designated host herein.

The host 210, which may include any computing environment comprising one or more processors 218 such as the processor 118 which may interface with the LIDAR system 100. For example, the host 210 may include one or more systems deployed and/or located in the vehicle 110 such as, for example, an ADAS, a vehicle control system, a vehicle safety system, a client device (e.g., laptop, smartphone, etc.), and/or the like. In another example, the host 210 may include one or more remote systems, for example, a security system, a surveillance system, a traffic control system, an urban modelling system, and/or other systems configured to monitor their surroundings. In another example, the host 210 may include one or more remote cloud systems, services, and/or platforms configured to collect data from vehicles 110 for one or more monitoring, analysis, and/or control applications. In another example, the host 210 may include one or more external systems, for example, a testing system, a monitoring system, a calibration system, and/or the like.

The host 210 may be configured to interact and communicate with the LIDAR system 100 for one or more purposes, and/or actions, for example, configure the LIDAR system 100, control the LIDAR system 100, analyze data received from the LIDAR system 100, and/or the like. For example, the host 210 may generate one or more depth maps and/or 3D models based on trace data, and/or depth data received from the LIDAR system 100. In another example, the host 210 may configure one or more operation modes, and/or parameters of the LIDAR system 100, for example, define an ROI, define an illumination pattern, define a scanning pattern, and/or the like. In another example, the host 210 may dynamically adjust in real-time one or more operation modes and/or parameters of the LIDAR system 100.

According to some embodiments disclosed herein, statistical analysis may be applied to identify one or more environmental conditions in the environment of the LIDAR system 100. Moreover, based on the statistical analysis, an impact and/or effect of the environmental conditions on functionality and performance of the LIDAR system 100, for example, performance degradation may be evaluated, estimated, and/or predicted.

The statistical analysis applied to analyze trace data, i.e., reflection signals captured by the sensor(s) 116 during a plurality of scanning cycles (frames) of the FOV 120 and/or part thereof, may reveal and/or or indicate a presence of a plurality of volumetrically dispersed targets corresponding to particulates associated with one or more environmental conditions in the environment of the LIDAR system 100 which are characterized by volumetric dispersion with varying degrees of particulate density, for example, ice, snow, rain, hail, dust, sand, fog, and/or the like.

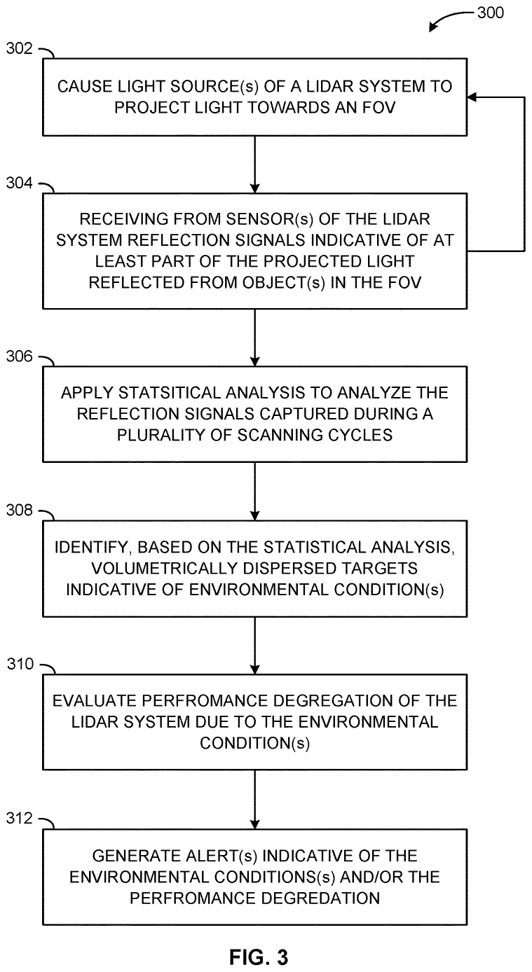

Reference is now made to FIG. 3, which is a flow chart of an exemplary process for detecting environmental conditions based on a statistical analysis of data generated by a LIDAR system, in accordance with embodiments of the present disclosure.

An exemplary process 300 may be executed for detecting one or more environmental conditions in an FOV such as the FOV 120 of one or more LIDAR systems such as the LIDAR system 100, for example, ice, snow, rain, hail, dust, sand, fog, and/or the like based on one or more statistical analyses. The environmental conditions may be associated with volumetrically dispersed targets, i.e., particulates, for example, particles, droplets, spray, vapors, and/or the like which may cause attenuation and/or scattering of the light 204 projected by the LIDAR system 100 and/or the light 206 reflected from one or more objects in the at least a portion of the FOV 102 which are illuminated by the projected light 204. The statistical analyses may therefore identify one or more light reflection patterns which may be indicative of the light attenuation and/or scattering behavior of the volumetrically dispersed targets.

The process 300 may be executed by one or more processors capable of operating the LIDAR system 100 and/or instructing the LIDAR system to operate. For example, the process 300 may be executed locally by one or more LIDAR systems 100, specifically by a processing unit such as the processing unit 108 comprising one or more processors such as the processor 118. In such case, the processor(s) 118 may directly operate one or more components of the LIDAR system 100, for example, a projecting unit such as the projecting unit 102, a scanning unit such as the scanning unit 104, and/or a sensing unit such as the sensing unit 106. The processor(s) 118 may also receive sensory data, specifically reflection signals (trace data) indicative of light captured by the sensing unit 106. In another example, the process 300 may be executed externally by one or more hosts such as the host 210 comprising one or more processors such as the processor 218 based on reflection signals (trace data) received from one or more LIDAR systems 100. In such case, the processor(s) 218 may communicate with the processor(s) 118 of the LIDAR system 100 to instruct and/or cause operation of one or more of the components of the LIDAR system 100. In another example, execution of the process 300 may be distributed between a LIDAR system 100 and an external the host 210 such that the process 300 is executed jointly by the processor(s) 118 of the LIDAR system 100 and the processor(s) 218 of the host 210.

For brevity, the process 300 is described herein after to be executed by a processor, designated executing processor, which may be implemented by any processing architecture and/or deployment including the local, external and/or distributed execution schemes described herein before.

As shown at 302, the process 300 starts with the executing processor causing one or more light sources such as the light sources 112 of the projecting unit 102 of the LIDAR system 100 to project light such as the projected light 204 toward at least a portion of the FOV 120 of the LIDAR system 100.

The at least a portion of the FOV 120 may correspond to a portion such as the portion 122. However, the at least a portion of the FOV 120 may include a plurality of portions 122 up to the entire FOV 120.

As shown at 304, the executing processor may receive reflection signals, i.e., trace data indicative of light captured by one or more sensors such as the sensor 116 of the sensing unit 106 of the LIDAR system 100. The light captured by the sensor(s) 116 may include reflected light such as the reflected light 206 which is reflected from the scene, i.e., from the one or more portion(s) of the FOV 120 illuminated with projected light 204. In particular, the reflected light 206 is reflected from one or more objects in the FOV 120 which are illuminated with the projected light 204.

Steps 302 and 304 of the process 300 may be repeated for a plurality of scanning cycles during which the scanned portion(s) of the FOV 120 are repeatedly scanned over time. Moreover, steps 302 and 304 of the process 300 may be repeated, typically with adjusted scanning parameters, for scanning other portion(s) of the FOV 120, also repeatedly over time.

As shown at 306, the executing processor may apply one or more statistical analyses to analyze data generated based on the reflection signals received from the sensor(s) 116 which are indicative of reflected light 206 reflected from the at least a portion of the FOV 120, specifically light reflected from one or more objects in the scene included in the at least a portion of the FOV 120.

In particular, the statistical analysis(s) may be applied to analyze the data generated based on reflection signals accumulated during the plurality of scanning cycles (frames) and thus indicative of reflected light 206 reflected from the at least a portion of the FOV 120 over time. Moreover, the statistical analysis(s) may be applied to analyze the data generated based on reflection signals corresponding to different ranges (distances) accumulated over time during a plurality of scanning cycles.

The data generated based on reflection signals and used by the statistical analysis may be stored locally at the LIDAR system 110, in one or more other systems installed at the vehicle 110 and/or remotely, for example, at one or more remote servers and/or cloud services. Additionally, and/or alternatively, the used data may be discarded after use to reduce utilization of memory resources of the LIDAR system 100 which may be limited, reduce traffic bandwidth of data transmitted from the LIDAR system 100, and/or the like. For example, the statistical analysis may employ moving window computations, for example, moving average, accumulated standard deviation, and/or the like in which an aggregated value is stored while the instantaneous sample values are used and discarded. For example, detections of an object at one or more distances and/or distance bins may be averaged over a plurality of scanning cycles by updating an average of detections computed for the detection in previous cycles according to a detection/no-detection result of a current scanning cycle and discarding the detection result of the current cycle. In another example, a standard deviation may be computed for a reflectivity level of one or more objects detected in the FOV 120 by updating the updating the standard deviation computed for the object's reflectivity in previous scanning cycles according to a reflectivity of the object determined in the current scanning cycle and discarding the reflectivity value of the current cycle.

The data generated based on reflection signals which is used by the statistical analysis may include, for example, the raw trace data (reflection signals) generated by the sensor(s) 116, data extracted from the trace data, data generated based on the trace data, for example, one or more cloud points, and/or a combination thereof. This data and/or part thereof may be stored and/or discarded after use to reduce utilization of memory resources of the LIDAR system 100 which may be limited. For example, the statistical analysis may employ moving window computations, for example, moving average, accumulated standard deviation, and/or the like in which an aggregated value is stored while the instantaneous sample values are used and discarded.

Based on analysis of the data generated based on the accumulated reflection signals (trace data), the statistical analysis(s) may therefore identify, map and/or otherwise indicate one or more detection parameters relating to detection of the LIDAR system 100, for example, a level of reflectivity of one or more objects in the at least a portion of the FOV 120 reflecting at least part of the projected light 204 over a plurality of different ranges, a detection range, a rate of false alarms (e.g., false positive, and/or true negative detections), a confidence level of detection, a confidence level of detection distance, a noise level, and/or the like. In particular, the statistical analysis(s) may be indicative of changes and/or variations in the reflectivity level of objects identified in the at least a portion of the FOV 120.

The statistical analysis(s) may comprise one or more statistical analysis techniques, methods, and/or algorithms applied to analyze one or more parameters of the data generated based on the accumulated trace data generated by the sensor(s) 116. For example, the statistical analysis may include computing and/or determining one or more measures of central tendency in an observed level of reflectivity of one or more objects identified in the at least a portion of the FOV 120, for example, a mean, an average, a variance, a standard deviation, and/or the like.

Moreover, the statistical analysis may further comprises determining the variation in the observed level of reflectivity in combination with distances between the LIDAR system 100 and one or more of the objects identified in the at least a portion of the FOV 120. For example, the statistical analysis may normalize the signal data (trace data) using the measured distance to one or more reflecting objects to extract the level of reflectivity of the respective object. While an object is detected in the FOV 120 and tracked over time, i.e., over a plurality of scanning cycles (frames), the statistical analysis may identify a variation in the level of reflectivity of the tracked object based on analysis of a plurality of samples of reflection signals captured by the sensor(s) 116 during the plurality of frames.

Moreover, based on analysis of the accumulated trace data indicative of the reflected light 206 from the at least portion of the FOV 120 during the plurality of scanning cycles, the statistical analysis may determine one or more changes and/or variations in a noise baseline identified for the light measured by the sensor(s) 116. The noise baseline may comprise noise relating to intermittent and/or inconsistent scattering and/or reflection of light 204 projected by the LIDAR system 100 from the scene illuminated by the projected light as well as noise resulting from ambient light that is unrelated to the light 204 projected by the LIDAR system 100, i.e., light which is not a result of reflections of the projected light 204. The ambient light may be a sum of background light signals such as, for example, sunlight, light emitted by one or more other illumination sources (e.g., other LIDAR systems, etc.), and/or the like which may interfere with detection of the reflected light 206 corresponding to the projected light 204 which is reflected from object(s) in the FOV 120.

The level of ambient noise may be determined, and/or established using one or more methods. For example, the ambient noise may be determined based on light captured by the sensor(s) 116 during one or more time periods in which reflected light 206 is not expected to be captured by the sensor(s) 116 during which the light captured by the sensor(s) 116 is assumed to include only the ambient (unrelated) light, for example, prior to projecting light 204, after a certain time post projection of projected light 204 after which no more reflected light 206 should arrive at the sensor(s) 116, and/or the like.

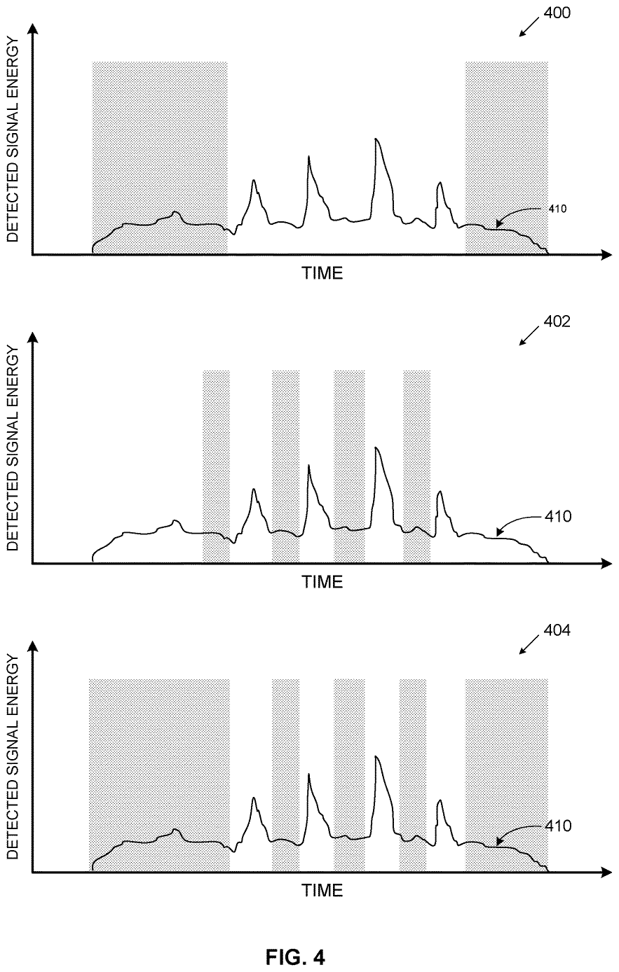

Reference is now made to FIG. 4, which depicts graph charts illustrating detection of noise relating to ambient light captured by a LIDAR system, in accordance with embodiments of the present disclosure.

Graph charts 400, 402 and 404 illustrate an exemplary reflection signal 410 (trace data) generated by one or more sensors such as the sensor 116 of a LIDAR system such as the LIDAR system 100 which are indicative of light received by the sensor(s) 116 as a function of energy (power) over time. As seen the reflection signal 410 includes several peaks corresponding to reflections of a series of light pulses projected by the LIDAR system 100 to scan the scene. As seen, the reflection signal 410 has a bias level which is indicative of noise resulting from detection of ambient light that is unrelated to the light projected by the LIDAR system 100.

In order to determine and/or establish a noise level relating to the ambient light, the light level may be measured during one or more ‘no light projection’ time periods where the light captured by the sensor 116 does not include reflected light 206 resulting from reflections of light 204 projected by the LIDAR system 100. As seen in graph chart 400, the no light projection time periods may include, for example, one or more time periods, marked by shaded areas, for example, before and/or after the peaks in the reflection signal 410 corresponding to the projected light pulses, i.e., before and/or sufficiently after projection time of the series of light pulses. In another example, as seen in graph chart 402, the ‘no light projection’ time periods may include one or more time periods (shaded areas) between adjacent peaks in the reflection signal 410 corresponding to projected light pulses, specifically after a certain time period following the preceding peak (light pulse) after which reflected light is no longer expected to arrive back to the sensor 116, i.e., after a time period corresponding to a distance (range) for which reflected light is negligible. In another example, as seen in graph chart 404, the no light projection time periods may include a plurality of time periods (shaded areas) including the time periods before and after the peaks in the reflection signal 410 corresponding to the projected light pulses as well as between adjacent peaks.

Reference is made once again to FIG. 3.

Optionally, the statistical analysis(s) may be applied to analyze data extracted from one or more point cloud models (point clouds) created based on the reflection signals. Such statistical analysis(s) may be applied to identify one or more reflection patterns of objects identified in the at least a portion of the FOV 120.

As shown at 308, based on the statistical analysis, the executing processor may identify volumetrically dispersed targets in the at least a portion of the FOV 120 indicative of one or more environmental condition currently present in the environment of the LIDAR system 100, for example, ice, snow, rain, hail, dust, sand, fog, and/or the like.

The volumetrically dispersed targets, i.e., particulates dispersed in the at least a portion of the FOV 120 may be highly indicative of one or more environmental condition which are characterized by particulates having significantly small volume and distributed relatively densely in the environment. Typically, depending on the light projecting and/or scanning parameters of the LIDAR system 100, the volumetrically dispersed targets having one or more particulate densities may be of the order and/or smaller than a diameter of light beams projected by the LIDAR system 100, for example, laser beams.

The executing processor may identify the environmental conditions since the statistical analysis(s) applied to the reflection signals captured by the sensor(s) 116 over time during a plurality of scanning cycles may reveal and/or indicate light reflection and/or scattering patterns which are indicative and/or correlated with one or more characteristics of the volumetrically dispersed targets, for example, a particulate density, an average particulate size, a precipitation density, and/or the like having values typical to one or more of the environmental conditions.

For example, the statistical analysis(s) applied to analyze the trace data may be indicative of variations and/or changes in the level of reflectivity of one or more objects identified in the at least a portion of the FOV which may be an indicator of an additional attenuation or scattering affecting the reflection of the light projected by the LIDAR system 100 from objects illuminated in the scene. For example, assuming that the statistical analysis determined a standard deviation of the level of reflectivity of a certain object tracked in a plurality of frames (scanning cycles) based on a plurality of samples captured during the plurality of frames. In case of free space loss only, the level of reflectivity should be relatively constant with respect to the distance (range) of the tracked object from the LIDAR system 100 and the detection range should be consistent with that reflectivity. However, in case of additional loss sources other than free space loss, specifically, presence of the volumetrically dispersed targets associated with one or more of the light conditions, the reflectivity level may change with range. As such, the standard deviation of the level of reflectivity versus time may be indicative of variation caused by the volumetric targets in the surrounding environment.

In another example, the statistical analysis may be indicative of changes in the noise baseline over a range, i.e., distances relative to the LIDAR system 100. As described herein before, the noise baseline may include a sum of the ambient light signals and light reflected and/or scattered by intermittent and/or inconsistent objects such as, for example, the volumetrically dispersed targets associated with the environmental condition(s). However, while the impact of the ambient light may be independent of the distance to the object and thus significantly constant over range, the impact and/or contribution of the light scattered by the volumetrically dispersed targets to the noise baseline may vary over range.

The variations and/or changes in the noise baseline, specifically variations and/or changes over range, may be therefore indicative of one or more volumetric reflection conditions induced by one or more of the environmental condition present in the environment of the LIDAR system 100, i.e., by the volumetrically dispersed targets associated with the environmental condition(s). It is appreciated that the volumetric reflection condition(s) induced by the environmental condition(s) may be significantly constant across the at least a portion of the FOV 120 scanned by the LIDAR system 100.

Moreover, the executing processor may identify, based on the statistical analysis, a dependency of the variation (variance) on the distance (range) of the reflecting objects which may be indicative of one or more of the environmental conditions. Different variations in the noise baseline for different distances identified by the statistical analysis may be also indicative of volumetric reflection condition(s) induced by the volumetrically dispersed targets associated with the environmental condition(s) present in the environment of the LIDAR system 100.

In particular, the volumetric reflection conditions may cause a higher standard deviation at a shorter range and lower standard deviation at a farther range. As such, an exemplary volumetric reflection condition may be expressed by a first average noise baseline determined based on the statistical analysis over a first range of time-of-flight values which is higher than a second average noise baseline determined based on the statistical analysis over a second range of time-of-flight values, where the different ranges of time-of-flight values correspond to different distances of the reflecting object from the LIDAR system 100.

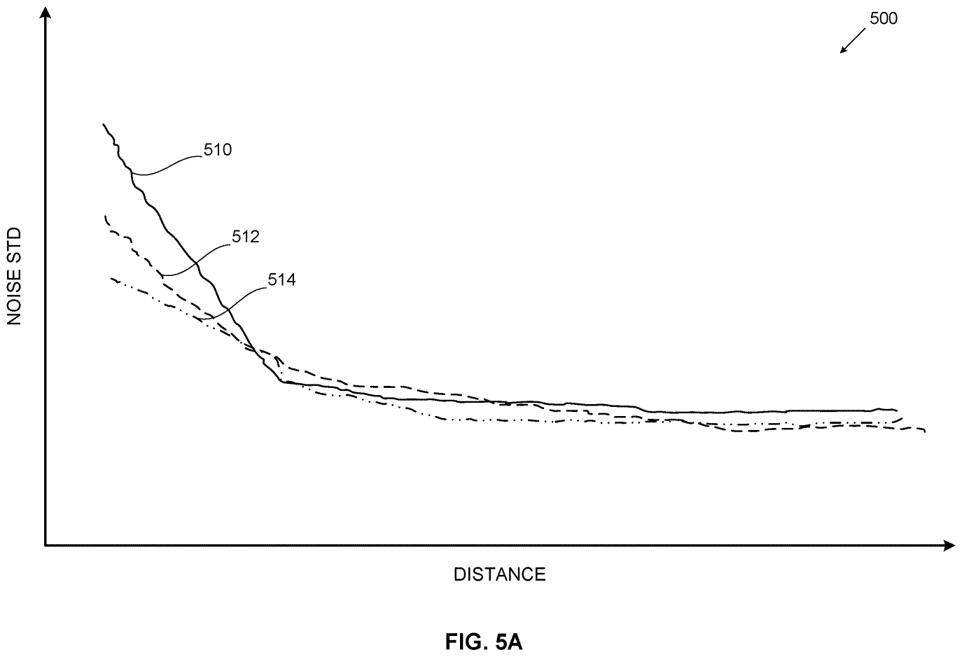

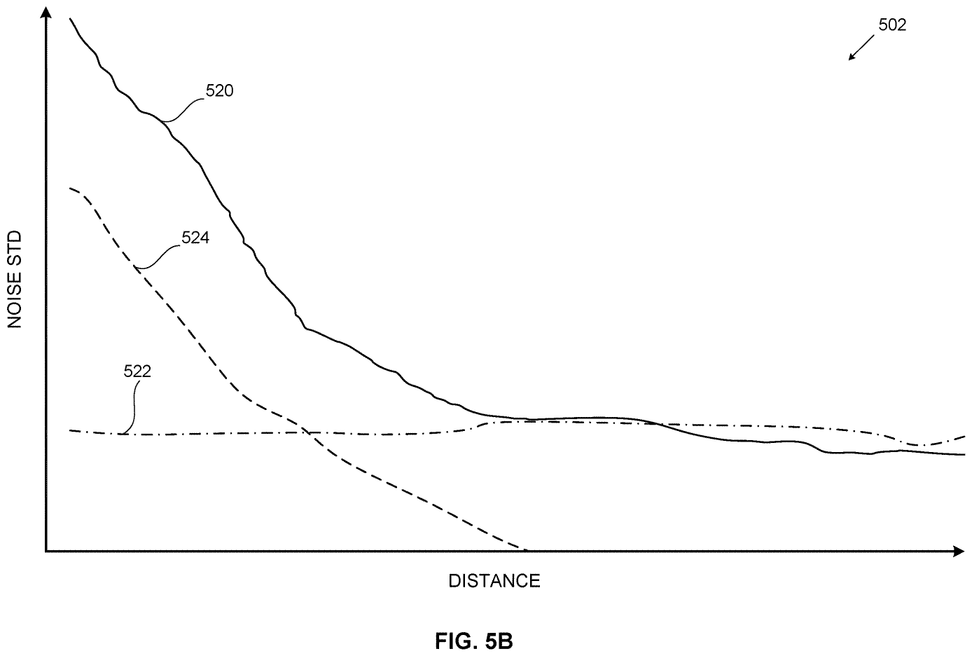

Reference is now made to FIG. 5A and FIG. 5B, which are graph charts illustrating standard deviation of noise captured by a LIDAR system with respect to range (distance), in accordance with embodiment of the present disclosure.

As seen in FIG. 5A, graph chart 500 illustrates a standard deviation 520 of baseline noise over distance (range) computed for an exemplary interference environment, i.e., an environment in which there is light interfering with light projected by the LIDAR system 100 including light resulting from volumetric reflection conditions induced by volumetrically dispersed targets associated with the environmental condition(s) present in an environment of a LIDAR system such as the LIDAR system 100.

In particular, graph chart 500 shows a standard deviation (STD) 510 of baseline noise over distance (range) computed for an exemplary high interference environment, a standard deviation 512 computed for an exemplary medium interference environment and standard deviation 514 in computed for an exemplary low interference environment.

As known in the art, light reflections from objects, in this case volumetric reflection conditions induced by volumetrically dispersed targets depend on the distance to the targets, specifically, the reflected light is attenuated by 1/L\hat{ }2. As evident in graph chart 500, the standard deviation is therefore significantly higher at shorter distance (range) and gradually decreases with the increase in the distance from the LIDAR system 100. Such patterns of noise having a high and gradually decreasing standard deviation as function of range may be highly indicative of the volumetrically dispersed targets associated with one or more of the environmental conditions since these patters indicate of the presence of actual objects, namely the volumetrically dispersed targets, which scatter light projected by the LIDAR system 100.

Moreover, the different graphs 510, 512, and 514 may be indicative of different environmental conditions. For example, the high interference environment expressed by the standard deviation 510 may be indicative of volumetrically dispersed targets having higher particulate density and/or larger particulates' average size associated, for example, with fog, snow, and/or the like. In another example, the low interference environment expressed by the standard deviation 514 may be indicative of volumetrically dispersed targets having lower particulate density and/or smaller particulates' average size associated, for example, with rain, hail, and/or the like.

Optionally, the statistical analysis may be configured to filter out noise relating to ambient light to the overall noise baseline to reduce and potentially remove impact, effect, and/or contribution of the ambient light to the noise baseline thus increasing accuracy of the determined noise induced by the volumetrically dispersed targets to increase performance, for example, accuracy, reliability, consistency, and/or the like of detection and/or classification of particulates associated with the environmental condition(s).

As seen in FIG. 5B, graph chart 502 illustrates a standard deviation 520 of baseline noise over distance (range) computed for an exemplary interference environment where at least part of the noise relates to volumetric reflection conditions induced by volumetrically dispersed targets associated with the environmental condition(s) present in an environment of a LIDAR system such as the LIDAR system 100.

Line 522 illustrates the impact, effect, and/or contribution of the ambient noise (e.g. sunlight) to the noise baseline, specifically the standard deviation of the ambient light which is significantly constant over range. The statistical analysis may adjust the standard deviation 520 to remove the impact of the ambient light as expressed by the standard deviation 522 to yield line 524 which may express the standard deviation of only the noise relating to the volumetric reflection conditions induced by the volumetrically dispersed targets associated with the one or more of the environmental conditions.

Reference is made once again to FIG. 3.

In another example, the executing processor may identify one or more of the environmental conditions based on the statistical analysis(s) applied to analyze the point cloud generated based on data extracted from the reflection signals generated by the sensor(s) 116.

For example, one or more of the environmental conditions may be detected based on statistical analysis of one or more variables such as, for example, one or more of the environmental conditions the detection range associated with one or more points in the point cloud. For example, one or more of the environmental conditions may be detected based on statistical analysis of one or more variables such as, for example, a detection range associated with one or more points in the point cloud. Based on such statistical analysis, the executing processor may identify one or more points in the point cloud which have no neighbor points and thus may be potentially indicative of one or more of the environmental conditions, specifically of points mapping single particulates of the volumetrically dispersed targets associated with the environmental condition(s).

In another example, the statistical analysis applied to analyze the point cloud may identify one or more light reflection distribution patterns indicative of volumetric reflection conditions induced by volumetrically dispersed targets associated with one or more of the environmental conditions. The light reflection distribution patterns may relate to one or more of the detection parameters analyzed by the statistical analysis, for example, detection rate (detection number) of an object over a plurality of scanning cycles, reflectivity level, detection range, false alarms, and/or the like.

For example, one or more light reflection distribution patterns identified based on the statistical analysis which reflect substantially uniform distribution of detections over range may be typical to actual objects, for example, a vehicle, a road, a traffic light, a traffic sign, a pedestrian, a structure, a water puddle on the road, and/or the like which may. In contrast, light reflection distribution patterns which are typical to the volumetrically dispersed targets may express non uniform, inconsistent, and/or irregular detections which may be indicative of light reflections, absorption or scattering of light in the environment which are not uniform and thus very different from the light reflection distribution pattern(s) of the actual objects.

In order to identify such light reflection distribution patterns, for example, light reflection patterns expressing reflections distribution indicative of volumetric reflection conditions, the statistical analysis may analyze, for example, light reflection distribution in one or more distance bins (ranges) in one or more instantaneous FOVs of the LIDAR system 100. Each distance bin may encompass a certain segment of the range in a respective instantaneous FOV, for example, 5 m, 10 m, 15 m, and/or the like such that the effective range of the LIDAR system 100 in the respective instantaneous FOV, for example, 150 m, 200 m, 250 m, and/or the like is segmented to a plurality of distance bins. As such each distance bin yᵢ may extend over a respective distance/length xᵢ, for example, in the range of

$${x}_{i} - \frac{{y}_{i}}{2} to {x}_{i} + \frac{{y}_{i}}{2} .$$

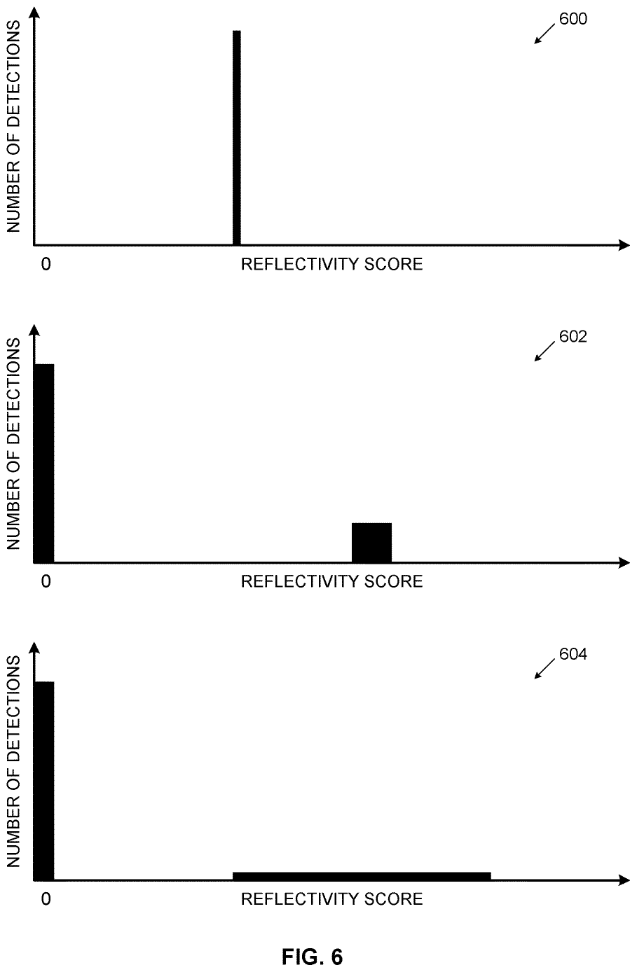

Reference is now made to FIG. 6 are graph charts illustrating exemplary light reflection patterns, detected based on analysis of a point cloud created based on data captured by a LIDAR system, indicative of environmental conditions, in accordance with embodiments of the present disclosure.

A seen in FIG. 6, graph charts 600, 602 and 604 illustrate histograms representing a reflectivity score of objects detected in an exemplary distance bin (range segment), for example, 10 m, at a certain distance, for example, 30 m in a certain instantaneous FOV of a LIDAR system such as the LIDAR system 100 over a certain time period, i.e., during a certain number of scanning cycles, for example, 20 frames. The reflectivity score may express a level of reflectivity, for example, energy of reflected light, an intensity, and/or the like.

The graph chart 600 illustrates a light reflection distribution pattern in which light is reflected with substantially similar reflectivity score from the distance bin during most if not all of the frames. Such reflection distribution pattern may be typical to reflections from a surface of an actual object since such a surface may maintain its level of reflectivity overtime.

On the other hand, a light reflection distribution pattern illustrated in the graph chart 602 shows a highly varying reflectivity score in the certain distance bin wherein most of the time, i.e., during most of the scanning cycles, the reflectivity score is 0 meaning that no objects are detected at the distance bin while in some of the scanning cycles the reflectivity score is substantially high. Such reflection distribution pattern may be typical to volumetrically dispersed targets associated with one or more of the environmental conditions since the light beam projected by the LIDAR system 100 may rarely be incident upon one or more of the volumetrically dispersed targets and thus the reflectivity score may be typically 0. However, on the rare occasion that the projected light beam is incident upon one of the volumetrically dispersed targets, the volumetrically dispersed target, for example a water droplet, may be a retroreflector and may reflect a large amount of light expressed by the high reflectivity score. In another example, graph chart 604 illustrates a light reflection distribution pattern in which most of the time, the reflectivity score is 0 meaning that no objects are detected at the distance bin while in some of the s scanning cycles the reflectivity score is substantially high. Such light reflection distribution pattern may also be typical to volumetrically dispersed targets.

However, as seen, in histogram 602, the high reflectivity score is substantially the same during the scanning cycles during which the light beam is incident upon the volumetric dispersed target while in histogram 604 the reflectivity score is substantially distributed and shows different reflectivity scores during different scanning cycles. The light reflection distribution pattern reflected by histogram 602 may be indicative of volumetric dispersed targets having higher particulate size (e.g., rain droplets) which is substantially the size of the light beam diameter at a given distance from the LIDAR system 100 and thus the light beam may be incident on only a single target having a substantially similar size and thus a similar reflectivity level. The light reflection distribution pattern reflected by histogram 604 on the other hand may be indicative of volumetric dispersed targets having lower particulate size (e.g., spray, dust, etc.) which are substantially smaller than the light beam diameter and the light beam may therefore be incident upon a different number of volumetric dispersed targets during some of the scanning cycles which may result in a different reflectivity score during these scanning cycles as seen by the histogram 604.

Moreover, the executing processor may identify one or more of the light reflection distribution patterns, for example, reflectivity score histograms with relation to the distance from the LIDAR system 100 of each distance bin to which the reflection distribution patterns relate. In particular, the executing processor may adjust to identify the light reflection distribution patterns which are distance dependent due to increased attenuation of light over distance as well as increased divergence of the light beams which may reduce probability of the light beam to hit volumetrically dispersed targets associated with the environmental condition(s). For example, the further away is the distance bin from the LIDAR system 100, the lower is the probability of the light beam to hit the volumetrically dispersed targets and the histogram of 0 reflectivity score of the respective distance bin may increase. In addition, when the light beam does hit one or more of the volumetrically dispersed targets, the reflected light may be highly attenuated due to the increased distance of the respective bin to the LIDAR system 100, and the reflectivity score associated with the volumetrically dispersed target hit by the light beam may be reduced.

In another example, one or more light reflection distribution patterns identified based on the statistical analysis may express false detections, interchangeably designated false alarms. The false detection relates to false detections made based on analysis of the traces data received from the sensor(s) 116 and may include, for example, false positive detections in which an object is falsely detected where there is no object (for example, caused by stray light or by another source of interference such as noise, crosstalk, etc.), a true negative detection in which an actual object is not detected, and/or the like.

False detections (alarms), for example, true negative detections, and specifically a high false alarm rate may be indicative of the volumetrically dispersed targets associated with the environmental conditions. Such the true negative detections may be identified, for example, based on detection of points in the point cloud which have no neighboring points. For example, the statistical analysis may accumulate detections of one or more objects over time, i.e., over a plurality of scanning cycles and create time histograms accordingly. Histograms showing inconsistent, irregular, and/or sporadic detections may indicate that these detections are false alarms which may be indicative of one or more of the environmental conditions. In another example, the light reflection distribution patterns expressing false positive detections may be generated by the statistical analysis based on trace data (reflection data) and/or point cloud regions relating to one or more areas in which there are assumed to be no reflecting objects, for example, based on trace data generated while the LIODAR system 100 is oriented to scan the sky. i.e., the LIDAR system 100 is directed toward the sky.

In another example, one or more light reflection distribution patterns identified based on the statistical analysis may express highly varying reflectivity level of one or more objects detected in the FOV 120 based on analysis of the point cloud. The statistical analysis may analyze reflection data (e.g., intensity, and/or energy values) associated with points in the pint cloud and may create histograms accordingly to express the reflectivity level over time, i.e., over a plurality of scanning cycles. Histograms showing inconsistent, irregular, and/or highly varying reflectivity of the object(s) may be indicative of the volumetrically dispersed targets associated with one or more of the environmental conditions.

Referring once again to FIG. 3.

As shown at 310, the executing processor may optionally evaluate, and/or estimate a performance degradation of the LIDAR system 100 as result of the presence of the environmental condition(s) identified in the environment of the LIDAR system 100.

The executing processor may estimate, based on the statistical analysis, an adverse performance impact of the environmental condition(s) on the performance of the LIDAR system 100. Moreover, based on the statistical analysis, the executing processor may therefore estimate an extent and/or degree of the adverse performance impact, for example, a magnitude of impairment of one or more operational capabilities of the LIDAR system 100, for example, a detection range, a detection resolution, an effective extent of the FOV 120, a certainty (confidence) of a determined distance to one or more objects identified in the at least a portion of the FOV 120, and/or the like.

The executing processor may determine magnitude of impairment of one or more of the operational capabilities of the LIDAR system 100 based on one or more of the detection parameters, for example, reflectivity level, detection range, false alarms (false positive, and/or true negative detections) and/or the like computed by the statistical analysis based on the trace data, for example, average, standard deviation, and/or the like. For example, the executing processor may estimate the magnitude of impairment of the detection range based on a magnitude of the standard deviation computed and indicated by the statistical analysis for the baseline noise since increased variation in the standard deviation in the detection range, for example, may be highly correlated with noise induced by the volumetrically dispersed targets associated with the environmental conditions. Noise induced by ambient light on the other hand may have lower correlation to the standard deviation in the detection range.

For example, a higher standard deviation of one or more of the detection parameters, for example, reflectivity level, detection range, false alarms, and/or the like may be indicative of volumetrically dispersed targets associated with one or more environmental conditions, for example, water, in the form of droplets, spray, mist, vapor, and/or the like in the surrounding environment of the LIDAR system 100. For example, water in one or more of its forms, may absorb and/or scatter the emitted and/or reflected light signals thus causing a certain level of attenuation or scattering of the light signals reflected from the scene which may increase the noise. The noise in turn may impact one or more properties of the time of flight signal, cause signal losses, which may decrease the detection range to one or more objects detected in the at least a portion of the FOV 120. In another example, water droplets may act as retroreflectors causing increased reflection which may increase variance in the reflectivity level and/or detection rate (number) over a plurality of scanning cycles which may be expressed vi an increased standard variation.

As such, the executing processor may estimate the magnitude of impairment of the detection range according to the value of the standard deviation of one or more of the detection parameters, for example, the larger the standard deviation, the more the maximum detection range is reduced. In another example, the lower the standard deviation, the higher may be the level of confidence (certainty) in a mean value of the range (distance) associated with one or more points in the point cloud.

In another example, the executing processor may estimate the magnitude of impairment of the detection resolution based on one or more characteristics of one or more of the environmental conditions indicated by the statistical analysis, for example, the particulate density, and/or the average particulate size of the volumetrically dispersed targets associated with one or more of the environmental conditions. For example, due to their light scattering behavior, large sized particulates and/or high particulate density may significantly reduce energy levels (power) of the projected light 204 and/or the reflected light 204 which may lead to reduced detection resolution at the sensor(s) 116 which in turn may reduce, for example, a resolution of one or more point clouds generated based on the reflection signals generated by the sensor(s) 116 according to the measured reflected light. For example, based on the statistical analysis, the executing processor may distinguish between light rain and a heavy rain based on the variation on the baseline noise, for example, based on the value (magnitude) of the standard deviation computed based on the statistical analysis since higher attenuation may be indicative of higher precipitation density, and/or larger particulate (droplet) size which is typical to heavy rain while lower precipitation density, and/or smaller particulate (droplet) size typical to light rain may induce lower attenuation and thus lower variation. In another example, based on the statistical analysis, the executing processor may distinguish between a foggy environment and a rainy environment since fog may create higher level of light scatter compared to rain droplets thus increasing the variation in the baseline noise.

In another example, the executing processor may estimate the magnitude of impairment of the certainty, i.e., the confidence level, of a detection and/or a distance of detection associated with a determined detection range. While the volumetrically dispersed targets associated with one or more environmental conditions may lead to reduction in the detection range of the LIDAR system 100, the density of the particles, i.e., the density of the volumetrically dispersed targets, in the environment of the LIDAR system 100 may affect the confidence level in determined detection range. For example, the higher the density, the more the confidence level is reduced. Such impacts may result in an increased rate of false positive and/or true negative detections which may reduce the confidence level of detected objects and/or their range. The executing processor may therefore estimate the magnitude of impairment of the confidence level according to the particulate density, and/or the precipitation density of the water particles computed and/or indicated by the statistical analysis.

Optionally, the executing processor may predict, based on the statistical analysis, an expected magnitude of impairment of one or more of the operational capabilities of the LIDAR system 100, for example, a 10% degradation in detection range, a 5% degradation resolution of one or more point clouds, and/or the like which is expected in a future time, for example, within 5 seconds (s) within 10 s, within 30 s, within 60 s, within 2 minutes, 5 minutes, and/or the like as result of the environmental condition(s) identified based on the statistical analysis. In other words, the executing processor may predict and/or estimate a future degree of adverse impact of the volumetrically dispersed targets associated with one or more of the environmental conditions on the performance of the LIDAR system 100.

For example, the executing processor may predict the magnitude of impairment of one or more of the operational capabilities based on comparison between the data and/or information derived by the statistical analysis based on the trace data and reference data and/or reference information retrieved from one or more lookup tables. Specifically, the lookup table(s) may associate between a plurality of datasets corresponding to the data generated based on the statistical analysis to indicate presence of the environmental condition(s) and respective magnitudes of impairment of the operational capability(s). The datasets stored in one or more of the lookup tables may be associated with respective magnitudes of impairment of the operational capability(s), for example, based on manual association done by one or more experts having knowledge in the domain of LIDAR system performance degradation in general and due to impact of environmental conditions in particular. In another example, the datasets stored in one or more of the lookup tables may be associated with respective magnitudes of impairment of the operational capability(s) based on data measured during a plurality of past events, and/or drives of one or more LIDAR systems such as the LIDAR system 100 in which the operational capabilities of the LIDAR systems were monitored while subject to the environmental conditions and their impact. In another example, the datasets stored in one or more of the lookup tables may be associated with respective magnitudes of impairment of the operational capability(s) based on simulated data generated during simulation of operation of one or more LIDAR systems such as the LIDAR system 100 under simulated environmental conditions and their impact.

In another example, the executing processor may apply, execute and/or otherwise use one or more ML models, for example, a Neural Network (NN), a classifier, a statistical a classifier, a Support Vector Machine (SVM), and/or the like adapted and trained to automatically determine a magnitude of impairment of one or more of the operational capabilities of the LIDAR system 100 due to impact of one or more of the environmental conditions identified based on the statistical analysis. The ML model(s) may be trained in one or more supervised, unsupervised, and/or semi-supervised training sessions using one or more training datasets comprising a plurality of training dataset each corresponding to the dataset used by the statistical analysis to estimate presence of the environmental condition(s). The training dataset may include, for example, one or more of the light reflection distribution patterns, for example, the histograms generated in the past for volumetrically dispersed targets associated with one or more of the environmental conditions. Optionally, one or more of the training datasets may be annotated (labeled), i.e., associated with a label indicative of a respective magnitude of impairment of one or more of the operational capabilities.

Optionally, the executing processor may further predict, based on the statistical analysis, that one or more of the operational capabilities of the LIDAR system 100 is expected fall to fall below one or more predetermined performance thresholds, i.e., threshold levels. For example, the executing processor may predict that the detection range is expected to fall (drop) below a certain predetermined thresholds, for example, 75%, 50%, and/or the like. In another example, the executing processor may predict that the confidence level in detection of one or more objects is expected to fall below a certain predetermined thresholds, for example, 80%, 75%, 60%, and/or the like. The executing processor may predict the expected fall of the operational capability(s) below the predetermined threshold(s), for example, based on the lookup table(s) mapping the magnitude of impairment of the operational capability(s) with respective datasets generated based on the statistical analysis for detecting the environmental condition(s). In another example, the executing processor may predict the expected fall of the operational capability(s) below the predetermined threshold(s) based on prediction made using one or more of the ML models trained to predict the magnitude of impairment based on the data generate by the statistical analysis.

Optionally, the executing processor may further predict, based on the statistical analysis, a time period, i.e., an amount of time until one or more of the operational capabilities is expected to fall below their respective predetermined performance thresholds, for example, within 5 seconds (s) within 10 s, within 30 s, within 60 s, within 2 minutes, 5 minutes, and/or the like. The executing processor may apply one or more methods, techniques, and/or algorithms to estimate and/or predict the amount of time until the operational capability(s) is expected to fall below the predetermined performance threshold(s), for example, based on the lookup table(s), using one or more of the trained ML models, and/or the like.

Optionally, the executing processor may identify presence of one or more of the environmental conditions in the environment of the LIDAR system 100 and/or an impact of the environmental condition(s) on performance of the LIDAR system 100 based on the statistical analysis combined with sensory data captured by one or more external sensor associated with the vehicle 110 on which the LIDAR system 100 is mounted, for example, an external light source, an ambient light sensor, a precipitation sensor, a wiper sensor, a temperature sensor, a humidity sensor, a camera, a RADAR, an ultrasonic sensor, and/or the like.

For example, the executing processor may estimate, evaluate, and/or otherwise determine identify one or more characteristics of environmental condition(s) identified in the environment of the LIDAR system 100 based on the statistical analysis in conjunction with data received from one or more external sensors, for example, a precipitation sensor installed in the vehicle 110 and configured to rain droplets. In another example, the executing processor may estimate, evaluate, and/or otherwise determine a degree of adverse performance induced by the environmental condition(s), for example, a magnitude of impairment of one or more of the operational capabilities of the LIDAR system 100 based on the statistical analysis in conjunction with data received from one or more external sensors, for example, an ambient light sensor configured to provide information on the level and/or amount of sunlight in the environment of the LIDAR system 100. The executing processor may adjust the noise baseline to reflect the contribution of the ambient light as measured by the ambient light sensor and thus increase accuracy of the noise induced by the volumetrically dispersed targets. By removing the noise induced by the ambient light, the executing processor may more accurately estimate the degree of adverse performance induced by the volumetrically dispersed targets associated with the environmental condition(s) present in the environment of the LIDAR system 100.

Optionally, the executing processor may identify presence of one or more of the environmental conditions in the environment of the LIDAR system 100 based on the statistical analysis combined with data associated with a location of the vehicle 110 on which the LIDAR system 100 is mounted. The location of the vehicle may be derived from one or more sensors and/or systems of the vehicle 110, for example, a geolocation sensor (e.g., GPS sensor), an inertial measurement unit (IMU), a dead reckoning system, a navigation system, a map database accessible to one or more systems of the vehicle 110, for example, the LIDAR system 100, and/or the like. The data associated with the location of the vehicle 110 may be received from one or more remote systems, for example, a remote server, a cloud service, and/or the like. For example, after determining the location of the vehicle 110, the executing processor may further evaluate and/or estimate one or more characteristics of the environmental condition(s) identified based on the statistical analysis in conjunction with data, for example, weather data relevant for the location of the vehicle 110. The weather data may be received, for example, from an online weather server, and/or service with which the LIDAR system 100 and/or the host 210 may communicate via one or more wireless communications channels, for example, cellular network, WLAN link, RF channel and/or the like. The executing processor may further estimate the magnitude of impairment of one or more of the operational capabilities of the LIDAR system 100 based on the statistical analysis in conjunction with the received weather data.

The executing processor may further predict future adverse performance impact of environmental condition(s) on the performance of the LIDAR system 100 based on data received from the remote server, and/or service, for example, a weather forecast indicative of one or more environmental conditions expected at the expected location of the vehicle 110 in the future, for example, in 5 minutes, in 10 minutes, and/or the like.

Optionally, the executing processor may identify, based on the statistical analysis, a presence of one or more blocking agents on a window associated with the LIDAR system 100, for example, the window 124, a window of the vehicle 110, and/or the like collectively designated LIDAR window herein after. The blocking agents may comprise, for example, ice, water droplets, smog, spray, dust, pollen, insects, mud, bird droppings and/or the like.

The performance of the LIDAR system 100 may obviously be affected by condition of the LIDAR window, for example, transparency, cleanliness, and/or the like which may be degraded, and/or compromised by accumulation of one or more of the blocking agents on the LIDAR window. For example, dust particles, water droplets, and/or the like may build up on the LIDAR window and degrade one or more of the operational capabilities of the LIDAR system 100, for example, reduce detection range, reduce horizontal and/or vertical FOV, impact detection and ranging capabilities in one or more ROIs in the FOV 120, cause false and/or unreliable object detections, and/or the like.

The presence of such blocking agent(s) on the LIDAR window may be detected based on the statistical analysis which may reveal, identify, and/or indicate one or more light reflection patterns indicative of blocking agent(s) accumulated on the LIDAR window. For example, assuming that, based on the statistical analysis, the executing processor identifies a first variation, for example, a first standard deviation in one or more first portions of the FOV 120 and a second variation, for example, a second standard deviation in one or more second portions of the FOV 120. Further assuming the standard deviation is typical to free space loss, optionally with presence of one or more of the environmental conditions while the second standard deviation is unsubstantial thus indicative of a uniform reflectivity across the entire range in the second portion(s) of the FOV 120. The executing processor may therefore determine, based on the statistical analysis, specifically based on the first and second standard deviations, that the LIDAR window associated with the second portion(s) is blocked.

Moreover, based on the statistical analysis, the executing processor may predict an amount of time (time period) until one or more of the operational capabilities of the LIDAR system 100 fall below one or more respective predetermined thresholds. In particular, the executing processor may predict the amount of time until the operational capability(s) fall below the predetermined threshold(s) based on an accumulation rate of the blocking agent(s) on the LIDAR window.

For example, assuming that based on the statistical analysis, the executing processor identifies that a variation, for example, a standard deviation computed for one or more portions of the FOV 120 is gradually increasing over time. In this case, the executing processor may determine, based on the gradually increasing standard deviation, that one or more sections of the LIDAR window associated with the one or more portions of the FOV 120 may be blocked by one or more of the blocking agents gradually accumulating on the LIDAR window. In such case, based on the rate of accumulation of the executing processor may predict the amount of time until one or more operational capabilities of the LIDAR system 100, for example, a horizontal and/or vertical FOV, a detection range, a rate of false detections, and/or the like fall below respective predetermined thresholds.

In another example, based on statistical analysis of the point cloud created based on trace data generate by the sensor(s) 116, the executing processor may identify a blockage in the FOV 120 indicative of at least partial blockage of the LIDAR window based on consistence presence of one or more points in the point cloud. The consistently obscured portion(s) of the FOV 120 may indicate accumulation of one or more blocking agents on the LIDAR window. In another example, the executing processor may identify, based on statistical analysis of the point cloud, one or more points having a distance corresponding to the distance of the LIDAR window from the sensor(s) 116 which may be indicative of one or more blocking agents accumulating on the LIDAR window.

As shown at 312, the executing processor may generate one or more alerts, indicative of the performance degradation in the LIDAR system 100, to one or more systems associated with the vehicle 110 on which the LIDAR system 100 is mounted, for example, an ADAS, an autonomous vehicle system, a safety system, and/or the like, designated vehicle control systems herein after.

The executing processor may transmit the alert via one or more communication channels, for example, via the communication interface 114 in case the executing processor is the processor 118, and/or via one or more communication channels of the host 210 in case the executing processor is the processor 218.

The alert may be indicative of one or more aspects relating to the environmental condition(s) identified in the environment of the LIDAR system 100. For example, the executing processor may generate one or more alerts indicative of presence of the environmental condition(s) in the environment of the LIDAR system 100, and optionally of a type, density, and/or one or more other attributes of the identified environmental condition(s). In another example, the executing processor may generate one or more alerts indicative of a performance degradation of the LIDAR system 100. In another example, the executing processor may generate one or more alerts indicative of a magnitude of impairment of one or more of the operational capabilities of the LIDAR system 100. In another example, the executing processor may generate one or more alerts indicative of a predicted magnitude of impairment of one or more of the operational capabilities of the LIDAR system 100 expected in a future time. In another example, the executing processor may generate one or more alerts indicative of an expected fall of one or more of the operational capabilities of the LIDAR system 100 below respective predetermined thresholds. In another example, the executing processor may generate one or more alerts indicative of an estimated time period (amount of time) until one or more of the operational capabilities of the LIDAR system 100 are expected fall of below the respective predetermined thresholds.

The vehicle control system(s) may thus take one or more actions, operations, and/or precautions according to the received alert(s) to encounter, compensate and/or mitigate the performance degradation in the LIDAR system 100. For example, assuming the received alert(s) is indicative of a reduced performance of the LIDAR system 100, the vehicle control system(s) may attribute less weight to detections received from the LIDAR system 100 compared to the output from one or more other sensors, and/or systems, for example, a camera, a proximity detector, and/or the like, specifically sensors, and/or systems which are less susceptible, i.e., less affected by the environmental condition(s) identified in the environment of the vehicle 110, optionally based on the statistical analysis.

In another example, the vehicle control system(s) may average points in the point cloud(s) over time to filter out variations in the detection range induced by the volumetrically dispersed targets associated with the identified environmental condition(s), for example, determine the range (distance) of one or more points in the point cloud based on a moving average calculated over a sample size of, for example, 5, 10 and/or 20 samples captured during a plurality of scanning cycles (frames).

Optionally, the executing processor may be configured to adjust one or more of the alerts it generated to include one or more recommended operational restrictions for the vehicle 110 on which the LIDAR system 100 is mounted vehicle control system(s). In other words the executing processor may propose, recommend, and/or instruct the vehicle control system(s) to take one or more actions according to the performance degradation of the LIDAR system 100 to reduce and potentially eliminate risk associated with performance limitations of the LIDAR system 100 caused by the environmental condition(s).

For example, the executing processor may recommend the vehicle control system(s) to initiate one or more actions, operations, and/or instructions, for example, imposing a speed limit, imposing separation distance limit relative to close-by vehicles, imposing limitation(s) on one or more selected maneuvers of the vehicle, and/or the like according to the type of the detected environmental condition(s), severity of system performance degradation caused by the environmental condition(s), type of system performance degradation experienced, and/or the like.

For example, assuming an autonomous vehicle 110, on which the LIDAR system 100 and controlled by an autonomous vehicle system control, is driving in a high-speed highway. In such case, the executing processor may generate one or more alerts comprising a recommendation to reduce the speed or even stop the autonomous vehicle 110 on the highway shoulder. In another example, the recommendations made by the executing processor and included in the alert(s) may comprise adjusting the actions and/or operations for controlling the autonomous vehicle 110 according to one or more traffic conditions identified in the environment of the autonomous vehicle, for example, presence of close-by vehicle, road conditions, and/or the like.

According to some embodiments disclosed herein, performance of one or more LIDAR systems such as the LIDAR system 100 may be evaluated using one or more reference objects identified in the environment of the LIDAR system 100. In particular, known attributes of the reference object(s) may be used to compute one or more LIDAR performance indicators relating to one or more of the operational capabilities of the LIDAR system 100 and evaluate accordingly the operational state and/or status of the LIDAR system 100.

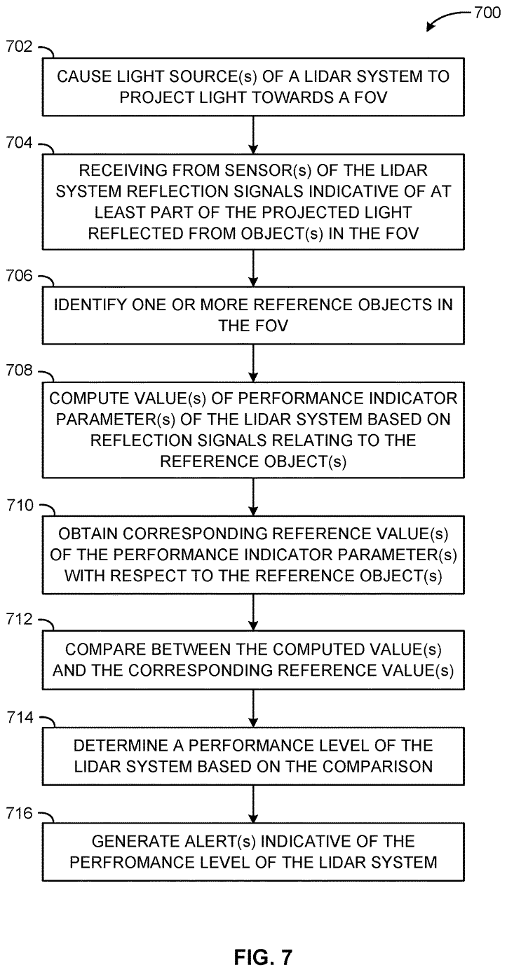

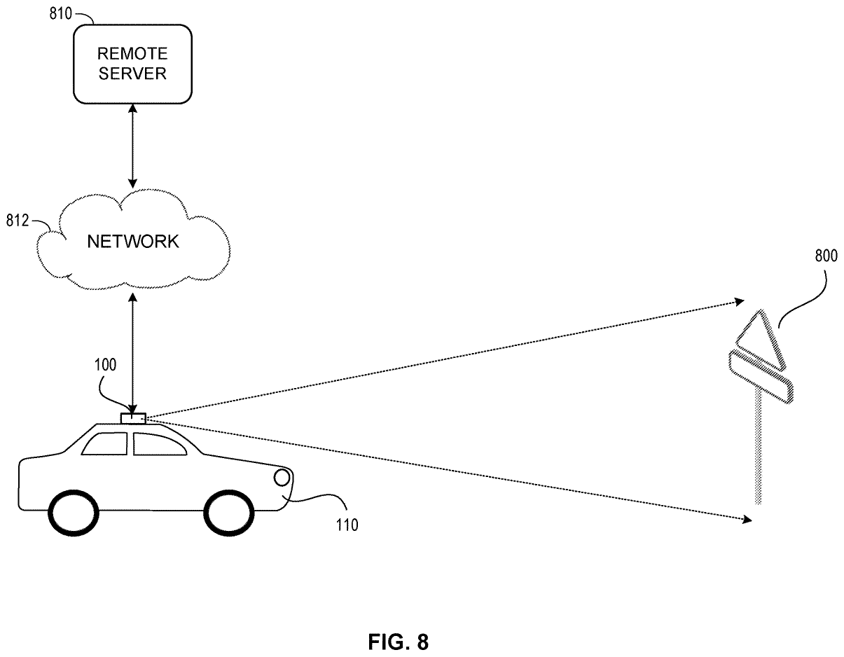

Reference is now made to FIG. 7, which is a flow chart of an exemplary process of determining performance level of a LIDAR system based on reference objects identified in the environment of the LIDAR system, in accordance with embodiments of the present disclosure. Reference is also made to FIG. 8, which is a schematic illustration of an exemplary system for determining performance level of a LIDAR system based on reference objects identified in the environment of the LIDAR system, in accordance with embodiments of the present disclosure.

An exemplary process 700 for determining performance level of a LIDAR system such as the LIDAR system 100 may be conducted by a processing unit such as the processing unit 108 of the LIDAR system 100. In particular, the performance level of a LIDAR system 100 may be evaluated, estimated, and/or otherwise determined based on one or more reference objects 800 identified in the environment of the LIDAR system 100, specifically in an FOV such as the FOV 120 of the LIDAR system 100.

One or more operational parameters, specifically LIDAR performance indicator parameters may be computed for the LIDAR system 100 with respect to the reference object(s) 800 and compared to corresponding reference values which are known for this reference object(s), for example, predetermined, measured in advance, crowdsourced and/or the like. The reference values of the performance indicator parameters may be stored locally at the LIDAR system 100 and/or in one or more remote servers 810, for example, a server, a database, a cloud service, and/or the like accessible to the LIDAR system 100 via a network 812 comprising one or more wired and/or wireless networks, for example, a LAN, a WLAN (e.g., Wi-Fi), a WAN, a Municipal Area Network (MAN), a cellular network, the internet, and/or the like.

The reference objects 800 may include one or more objects deployed and/or located in the environment of the LIDAR system 100 such that the reference objects 800 may be observed by the LIDAR system 100. For example, one or more reference objects 800 deployed in a certain location may be observed by a LIDAR system mounted on a vehicle such as the vehicle 110 when the vehicle 110 is located in proximity to the certain location and the reference objects 800 are in the FOV 120 of the LIDAR system 100.

The reference objects 800 may include one or more general objects, for example, traffic infrastructure objects such as, for example, a traffic light, a traffic sign, and/or the like. In another example, the general objects may include one or more structures, for example, a bridge, a monument, a structure and/or the like. However, the reference objects 800 may include one or more custom and/or dedicated reference objects, for example, LIDAR calibration targets, retroreflectors, and/or the like specifically deployed to serve as reference objects 800 detectable by the LIDAR system 100. Such reference objects 800 may be affixed and/or attached to various types of road and/or traffic infrastructure, for example, poles, signs, guard rails, barriers, overpasses, and/or the like. Additionally and/or alternatively, one or more reference objects 800 may be mounted on one or more vehicles such as the vehicle 110, and/or may consist of existing parts of a vehicle such as a license plate, tail-lights, and the like.

In particular, each of the reference objects 800 may have one or more characteristics, for example, a reflectivity level, a size, a shape and/or the like making the respective reference object 800 distinguishable and identifiable by the LIDAR system 100 based on the light (or spatial light pattern) reflected from the respective reference object 800. For example, one or more reference objects 800 may comprise one or more blooming reference objects. Each blooming reference object may be shaped, constructed, and/or configured to induce one or more blooming effects, for example, vertical blooming, horizontal blooming, perimeter blooming, circular blooming, and/or the like.

In another example, one or more of the reference objects 800 may have a reflectivity level which is characterized by spatial variation, i.e., the respective reference object 800 may have spatially varying and/or spatially dependent reflectivity. The spatially dependent reflectivity of the reference object 800 may enable accurate, reliable, and/or robust identification of the spatially dependent reflectivity reference object 800 based on the light reflected from it and detected by the LIDAR system 100.

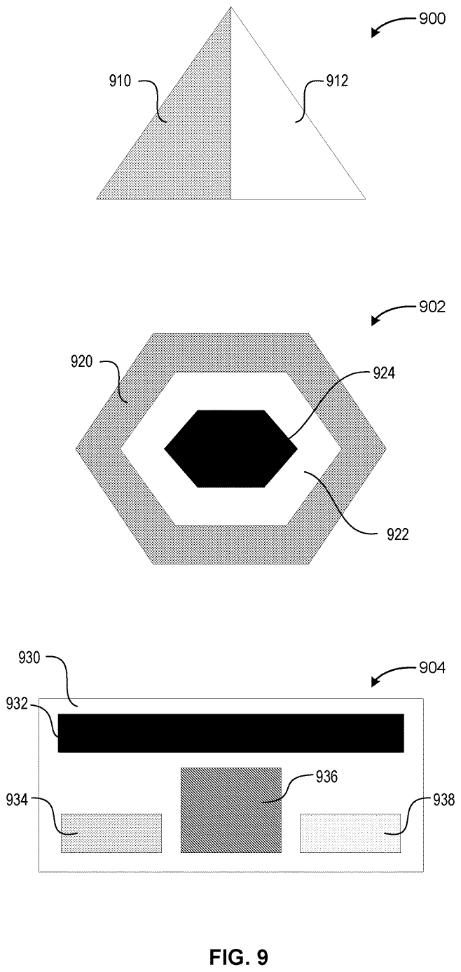

Reference is now made to FIG. 9, which illustrates exemplary reference objects having spatially varying reflectivity, in accordance with embodiments of the present disclosure. A first exemplary reference object 900 having a triangular shape may include two regions having different reflectivity levels, for example, a first region 910 having a first reflectivity level, and a second region 912 having a second reflectivity level different from the first reflectivity level, for example, higher reflectivity and/or lower reflectivity.

A second exemplary reference object 902 having a hexagon shape may include three regions, for example, a first region 920 having a first reflectivity level, a second region 922 having a second reflectivity level, and a third region 924 having a third reflectivity level. The first, second and third reflectivity levels may be all different from each other. In another example, the first and third reflectivity levels may be the same while different from the second reflectivity level such that the three regions 920, 922, and 924 may be distinguished from each other through the different reflectivity middle region 922.

A third exemplary reference object 904 having a rectangular shape may include one or more regions disposed on background region 930, for example, a first region 932 having a first reflectivity level, a second region 934 having a second reflectivity level, a third region 936 having a third reflectivity level, and a fourth region 938 having a fourth reflectivity level. The background region 930 may have a fifth reflectivity level. As described for reference object 902, the first, second, third, fourth, and fifth reflectivity levels may be all different from each other. However, in another exemplary embodiment, the first, second, third and/or fourth reflectivity levels may be the same while different from the fifth reflectivity level such that the four regions 932, 934, 936, and 938 may be distinguished from each other through the different reflectivity background region 930.

In another example, the reference objects 800 may include one or more active reference light sources configured to emit light which may be detected by the sensor(s) 116 of the LIDAR system 100. The active reference light sources may include, for example, one or more light sources configured to continuously and/or periodically emit light, for example, a continuous wave light source, a pulsing light source, and/or the like. In another example, the active reference light sources may include one or more reactive light sources configured to emit light responsive to illumination from the LIDAR system 100. In other words, in its normal operation mode, the reactive light source(s) may be configured not to emit light and emit light only after illuminated by light 204 projected by the LIDAR system 100.

One or more of the reference objects 800 may combine one or more elements, characteristics and/or effects. For example, one or more blooming reference objects may have spatially dependent reflectivity, for example, one or more blooming reference objects may consist of one or more regions of high reflectivity surrounded by regions of low reflectivity.

Reference is made once again to FIG. 7.

As described for the process 300, the process 700 may be executed by one or more processors capable of operating the LIDAR system 100 and/or instructing the LIDAR system to operate, for example, locally at the LIDAR systems 100 by a processing unit such as the processing unit 108, remotely a host such as the host 210, jointly by the processing unit 108 and the host 210 in a distributed manner, and/or the like. For brevity, the process 700 is described herein after to be executed by a processor, designated executing processor, which may be implemented by any processing architecture and/or deployment including the local, external and/or distributed execution schemes described herein before.

As shown at 702, the process 700 starts with the executing processor causing one or more light sources such as the light sources 112 of the projecting unit 102 of the LIDAR system 100 to project light such as the projected light 204 toward at least a portion of the FOV 120 of the LIDAR system 100. The at least a portion of the FOV 120 may correspond to a portion such as the portion 122. However, the at least a portion of the FOV 120 may include a plurality of portions 122 up to the entire FOV 120.

As shown at 704, the executing processor may receive reflection signals, i.e., trace data indicative of light captured by one or more sensors such as the sensor 116 of a sensing unit such as the sensing unit 106 of the LIDAR system 100. The light captured by the sensor(s) 116 may include reflected light such as the reflected light 206 which is reflected from the scene, i.e., from one or more objects in the portion(s) 122 of the FOV 120 illuminated by the projected light 204.

Optionally, steps 702 and 704 of the process 700 may be repeated for one or more additional scanning cycles (frames) during which one or more portions 122 of the FOV 120 may be scanned, either the same portion(s) 122, and/or one or more other portions 122. Moreover, steps 702 and 704 may be repeated with adjusted scanning parameters for scanning other portion(s) of the FOV 120.

As shown at 706, the executing processor may identify one or more reference objects 800 in the at least a portion of the FOV 120 scanned by the LIDAR system 120.

The executing processor may identify the reference object(s) 800 based on analysis of the trace data (reflection signals) generated by the sensor(s) 116. For example, the executing processor may identify one or more reference objects 800 by analyzing a point cloud generated, as described herein before, for the at least a portion of the FOV 120 based on the trace data (reflection signals) received from the sensor(s) 116 which are indicative of at least part of the reflected light 206, i.e., at least part of the projected light 204 reflected from objects in the least a portion of the FOV 120. For example, an exemplary reference object 800 may be shaped to have a certain shape which may be identified in the point cloud. The identifiable shape may include a certain 3D shape of the reference object 800 and/or a 2D shape of one or more surfaces of the reference object 800. In another example, an exemplary reference object 800 may have a certain reflectivity pattern which may be easily identified based on reflectivity data extracted from the point cloud. The reflectivity pattern of each reference object 800 may relate to reflectivity characteristics of the entire 3D reference object 800, to reflectivity characteristics of one or more 2D surfaces of the reference object 800, and/or to reflectivity characteristics of one or more sections of one or more of the 2D surfaces of the reference object 800.

Optionally, the executing processor may identify one or more reference objects 800 based on localization information of the respective reference object 800 with respect to the LIDAR system, i.e., a location, position, orientation, and/or the like of the respective reference object 800 with respect to location, position, orientation, and/or the like of the LIDAR system 100. The localization information may be determined based on data received from one or more localization sensor associated with the LIDAR system 100 and/or based on data retrieved from one or more of the remote servers 810. For example, the executing processor may determine the location of the vehicle 110, on which the LIDAR system 100 is mounted, based on data received from one or more sensors and/or systems of the vehicle 110, for example, a geolocation sensor (e.g., GPS sensor), an IMU, a dead reckoning system, a navigation system, a map database accessible to one or more systems of the vehicle 110, for example, the LIDAR system 100, and/or the like. After determining the location of the LIDAR system 100, the executing processor may access one or more storage resources, for example, a local storage at the vehicle 110 and/or a remote storage at the remote server(s) 810 to retrieve localization information of one or more reference objects 800 located in proximity to the location of the vehicle 110, in particular, reference objects 800 which are in the line of sight of the LIDAR system 100, and more specifically reference objects 800 which are in the FOV 120 of the LIDAR system 100. For example, a map of a certain area may map one or more reference objects 800 located in the certain area and may further include reference values of one or more LIDAR performance indicators parameters and/or LIDAR interaction properties relating to each of the mapped reference objects 800.

As shown at 708, the executing processor may compute, based on the reflection signals, a value of one or more LIDAR performance indicator parameters of the LIDAR systems 100. Typically, the LIDAR performance indicator parameter(s) may be computed in real-time.

The LIDAR performance indicator parameters may relate to one or more operational capabilities of the LIDAR system 100 which are indicative of the operational status, and/or the performance of the LIDAR system 100. The operational capabilities of the LIDAR system 100 may comprise, for example, a detection range (distance), a reflectivity level associated with one or more reference objects 800, a detection confidence level, a signal to noise ratio (SNR), a noise level, a false detection rate (e.g., false positive, true negative, etc.), a distance of first-detection, and/or the like.

For brevity, the terms LIDAR performance indicator parameters and operational capabilities are used interchangeably herein after where the operational capabilities are typically used as reference to the operational capabilities in general and the LIDAR performance indicator parameters relate to the values of the operational capabilities with respect to the reference objects 800.

The executing processor may therefore compute and/or evaluate the value of the LIDAR performance indicator parameter(s) for the LIDAR systems 100 with respect to one or more reference objects 800 identified in the FOV 120, specifically with respect to one or more of the characteristics of the identified reference objects 800. The characteristics of each reference object 800, for example, the reflectivity level, the shape, the size, and/or the like may be identified and/or determined, as known in the art, based on analysis of the trace data, i.e., the reflection signals relating to the respective reference object 800 which are received from the sensor(s) 116.

The light reflected by each reference object may depend on the characteristics of the respective reference object 800 and the executing processor may therefore compute LIDAR performance indicator parameter(s) with respect to the respective reference objects 800 according to the light reflection specific to the respective reference object 800 which is expressed by the reflection signals generated by the sensor(s) 116. For example, an exemplary reference object 800 may have a rectangular shape characterized by a certain reflectivity level. In such case, based on the reflection signals indicative of light reflected from the exemplary reference object 800 and its reflectivity level, the executing processor may compute the values of one or more of the LIDAR performance indicator parameters (operational capabilities), for example, the detection range of the exemplary reference object 800, the reflectivity level associated with the exemplary reference object 800, the SNR, and/or the like.

Moreover, the executing processor may be configured to adjust the value of one or more of the LIDAR performance indicator parameters computed with respect to one or more of the reference objects 800 which have spatially dependent reflectivity, in particular, based on the reflection signals indicative of the spatially dependent reflectivity. For example, an exemplary reference object 800 may have a triangular shape having a center high reflectivity region (high reflectivity level) surrounded by a low reflectivity perimeter region (low reflectivity level). In such case, based on the reflection signals indicative of light reflected from the high and low reflectivity regions of the exemplary reference object 800, the executing processor may compute and/or adjust the values of one or more of the LIDAR performance indicator parameters (operational capabilities). Combinations of reflectivity measurements from different regions of the reference objects 800 having different reflectivity characteristics may be used to increase confidence in the determination of the operational parameter. For example, each region of a reference object 800 may have an expected reflectivity value. accounting for the distance of the LIDAR system 100 from the reference object 800. The expected values may be compared to the actual values computed for each region. The relationships between expected reference values and actual computed values may indicate operational parameters. For example, a decreased reflectivity by an equivalent proportion for each region may indicate decreased sensitivity of the LIDAR sensing unit 106. Alternatively, a uniform decrease in reflectivity for each region may indicate environmental interference and maximum range of detection.

As shown at 710, the executing processor may obtain reference values of one or more of the LIDAR performance indicator parameters with respect to one or more of the reference objects 800 identified in the FOV 120. The reference values may comprise values and/or value ranges reflecting normal operation and/or performance of the LIDAR system 100.

Specifically, the executing processor may obtain reference value(s), i.e., reference values of LIDAR performance indicator parameter(s) corresponding to those computed by the executing processor in step 708.

The reference values of the LIDAR performance indicator parameters measured with respect to each of the reference objects 800 may be obtained from one or more sources.

For example, the reference values of one or more of the LIDAR performance indicator parameters may comprise predefined and/or predetermined values. The predefined reference values may be defined and/or determined based, for example, on calibration measurements of the LIDAR performance indicator parameters with respect to one or more of the reference objects 800 using verified test equipment. In another example, the predefined values may be defined and/or determined based on simulation of light reflection of one or more of the reference objects 800 in their environmental location for a known reflectivity or reflectivity pattern.

In another example, the reference values of one or more of the LIDAR performance indicator parameters may comprise crowdsourced values determined based on aggregation of a plurality of crowdsourced measurements of the respective LIDAR performance indicator parameter computed by a plurality of LIDAR systems such as the LIDAR system 100 with respect to one or more of the reference objects.

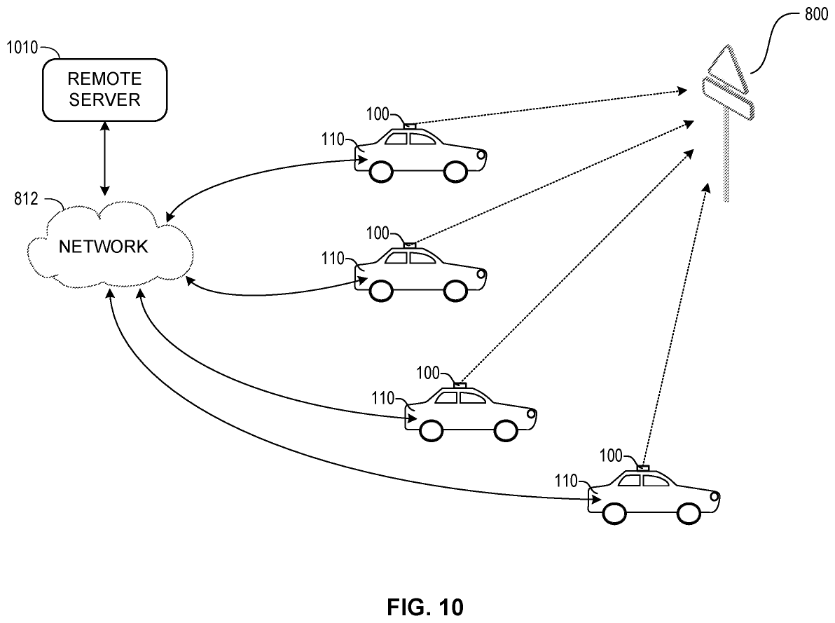

Reference is now made to FIG. 10, which is a schematic illustration of an exemplary system for updating values of LIDAR performance indicator parameters of LIDAR systems based on crowdsourced measurements computed by a plurality of LIDAR systems for reference objects, in accordance with embodiments of the present disclosure.

A plurality of LIDAR systems such as the LIDAR system 100 mounted on a plurality of vehicles such as the vehicle 110 may compute values of one or more of the LIDAR performance indicator parameters with respect to one or more reference objects 800 deployed at one or more locations. In particular, while the vehicles 110 travel (drive) in proximity to the reference object(s) 800 such that the reference object(s) 800 are visible in the FOV of the LIDAR systems 100, the values of the LIDAR performance indicator parameter(s) may be computed and/or determined based on the reflection signals received from the sensors 116 of these LIDAR systems 100 which are indicative of the light reflected from the reference object(s) 800.

The plurality of values measured by the plurality of LIDAR systems 100 for one or more of the LIDAR performance indicator parameters with respect to each of one or more of the reference objects 800, may be uploaded to one or more remote servers 1010 such as the remote server 810 which are in communication with the LIDAR systems 100 via a network such as the network 812.

The plurality of values measured by the plurality of LIDAR systems 100 with respect to each reference object 800 may be aggregated, for example, by the remote server(s) 1010 to create a respective crowdsourced value of the respective LIDAR performance indicator parameter with respect to the respective reference object 800, for example, an average, a standard deviation, and/or the like.

In particular, the crowdsourced values of the respective LIDAR performance indicator parameter(s) may be computed based on an aggregated value associated with one or more LIDAR interaction properties of the plurality of LIDAR systems 100 with the respective reference object 100. The LIDAR interaction properties are basically similar to the LIDAR performance indicator parameters, for example, detection range, reflectivity level, detection confidence level, SNR, noise level, false detection rate, distance of first-detection, and/or the like. However, the LIDAR interaction properties are designated as such to indicate that the crowdsourced values of LIDAR performance indicator parameters are computed based on interaction of the plurality of LIDAR systems 100 with the reference objects 800, specifically by aggregating the values measured for one or more of the LIDAR interaction properties with respect to a respective one of the one or more reference objects 800.

Moreover, one or more of the LIDAR interaction properties, i.e., the crowdsourced values of one or more of the LIDAR performance indicator parameters may be updated based on aggregation of a plurality of crowdsourced measurements captured by the plurality of LIDAR systems 100 with respect to one or more of the reference objects 800 over time. As such, the crowdsourced values of the LIDAR performance indicator parameters may be kept up to date thus accurately reflecting the characteristics of the reference object(s) 800 which may vary over time. For example, the reflectivity level of one or more of the reference objects 800 may vary over time, for example, degrade over time due to, for example, material deterioration, fading, and/or the like thus affecting one or more of the LIDAR performance indicator parameters, for example, the detection range, the measured reflectivity level, the SNR, the distance of first-detection, and/or the like. However, by aggregating the crowdsourced measurements, i.e., the LIDAR interaction properties captured by the plurality of LIDAR systems 100 over time with respect to the respective reference object(s) 800, the crowdsourced reference values of the LIDAR performance indicator parameters may be updated according to the current characteristic(s) of the reference object(s) 800. On the other hand, as opposed to slow changes (e.g., weeks, months, years) in the characteristics of reference objects 800, fast changes (e.g., seconds, minutes, hours) may be indicative of external impact, for example, impact of one or more environmental conditions which may affect the characteristics of the reference objects 800.

The predefined reference values and/or the crowdsourced reference values of the LIDAR performance indicator parameters may be stored in one or more storage resources accessible to the executing processor which may retrieve them. The storage resources may include, for example, local storage at the vehicle 110, for example, a storage component, device, and/or system of the LIDAR system 100. In another example, the storage resources may include one or more remote storage resources, for example, a server, a database, a cloud service, and/or the like accessible to the executing processor via the network 812.

In another example, the reference values of one or more of the LIDAR performance indicator parameters may comprise one or more values received via wireless communication from one or more other LIDAR systems 100 in the vicinity, i.e., in wireless communication range of the LIDAR system 100, for example, another LIDAR system 100 mounted on another vehicle 110 which is in proximity, specifically in wireless communication range of the vehicle 100 on which the LIDAR system 100 is mounted. For example, a first LIDAR system 100 mounted on a first vehicle 110 may compute values of one or more LIDAR performance indicator parameters with respect to a certain reference object 800 identified at a certain location. The first LIDAR system 100 may then transmit its computed values to a second LIDAR system 100 mounted on a second vehicle 110 located in proximity to the first vehicle 110, specifically at the certain location. The second LIDAR system 100 may use the received value(s) as reference value(s) for the LIDAR performance indicator parameter(s) with respect to the certain reference object 800.

Reference is made once again to FIG. 7.

As shown at 712, the executing processor may compare between the value(s) of the LIDAR performance indicator parameter(s) computed with respect to one or more reference objects 800 (in step 708) and corresponding reference value(s) obtained for the at LIDAR performance indicator parameter(s) with respect to the respective reference objects 800 (in step 710).

As shown at 714, the executing processor may determine a performance level of the LIDAR system 100 based on the comparison between the computed value(s) and the corresponding reference value(s) of the LIDAR performance indicator parameter(s) with respect to the respective reference object(s) 800.

The executing processor may determine the performance level of the LIDAR system 100 based on values computed using a single sample captured by the sensor(s) 116 or based on multiple samples captured by the sensor(s) 116.

The performance level of the LIDAR system 100 associated with various operational aspects of the LIDAR system 100 may be expressed by the values of the operational capabilities of the LIDAR system 100 which in turn may be evaluated and quantified based on the LIDAR performance indicator parameter(s) measured and/or computed with respect to the reference object(s) 800 in comparison with corresponding reference values which are used as the ground truth or normal values of the LIDAR performance indicator parameters.

A difference between computed values and corresponding reference values, which reflect normal operation of the LIDAR system 100, specifically normal performance level of one or more of the operational capabilities of the LIDAR system 100, may indicate that the performance of the LIDAR system 100 may deviate from its normal and/or nominal values.

The executing processor may be therefore configured to determine a state of one or more of the operational capabilities of the LIDAR system 100, for example, whether the respective operational capability is within a predetermined normal operating range, whether the respective operational capability falls below a predetermined threshold, whether a magnitude by which the respective operational capability falls below the predetermined threshold, and/or the like. Based on the state of one or more of the operational capabilities, the executing processor may determine the performance level of the LIDAR system 100. For example, a computed value of the detection range with respect to a certain reference object 800 which is similar or higher than the corresponding detection range reference value with respect to a certain reference object 800 may indicate normal and/or high performance level of the LIDAR system 100 while a reduced detection range of the certain reference object 800 compared to the reference value may be indicative of a low performance level of the LIDAR system 100.

In another example, the executing processor may calibrate, and/or evaluate performance of the LIDAR system 100 according to one or more blooming reference objects 800. For example, assuming the executing processor identifies, in step 708, a certain blooming pattern for a certain blooming reference object 800. In case the identified blooming pattern matches a known blooming pattern of the blooming reference object 800, the executing processor may determine that the LIDAR system 100 operates as expected with respect to blooming effects and may use algorithms, and/or mechanisms employed to overcome, and/or compensate for such effects. However, in case the identified blooming pattern does not match the known blooming pattern of the blooming reference object 800, the executing processor may determine that performance of the LIDAR system 100 is degraded and such compensation algorithms may be ineffective and/or unapplicable. Moreover, based on the deviation of the identified blooming pattern from the known and/or predefined blooming pattern, the executing processor may establish, and/or determine new blooming effect values for the compensation algorithms based on the extent of deviation.

The executing processor may be further configured to determine, for example, assess, estimate, and/or compute a magnitude of impairment of one or more of the operational capabilities of the LIDAR system 100.

The executing processor may be further configured to track changes in the performance level of the LIDAR system 100 over time. In particular, the executing processor may track changes in one or more of the operational capabilities of LIDAR system 100 which are indicative of the performance level.

By tracking the values of the operational capabilities of LIDAR system 100 overtime, the executing processor may detect a rate of degradation and/or decline in the performance level associated with one or more of the operational capabilities based on the tracked changes. For example, based on the comparison of measured values of a certain LIDAR performance indicator parameter, for example, the detection range computed with respect to a plurality of reference objects 800, the executing processor may identify that the detection range operational capability of the LIDAR system 100 is declining, and may further detect, compute, and/or determine the rate of decline in the detection range.

Optionally, the executing processor may be further configured to predict a time at which the performance level associated with one or more of the operational capabilities is expected to cross a predetermined threshold, for example, to exceed, to fall below, exit a predefined range, and/or the like. The predicted time may be expressed in one or more units, and/or terms, for example, within 10 s, within 30 s, within 60 s, within 2 minutes, 5 minutes, and/or the like.

The executing processor may apply one or more methods, techniques, and/or algorithms to estimate and/or predict the time until the performance level associated with the respective operational capability is expected to cross a predetermined threshold. For example, the executing processor may predict the time according to corresponding reference degradation rate values logged and measured in the past for one or more of the operational capabilities in one or more LIDAR systems such as the LIDAR system 100. In another example, the executing processor may use one or more ML models trained to predict the time until the operational capability crosses the predetermined threshold according to an identified degradation rate in LIDAR systems such as the LIDAR system 100.

Optionally, the executing processor may be further configured to determine an operational status of the LIDAR system 100 based on the comparison between the computed values of the LIDAR performance indicator parameters and the corresponding reference values.

The operational status may relate to one or more possible malfunctions, failures, and/or limitations which may degrade operation and/or performance of the LIDAR system 100, for example, a blockage of a window associated with the LIDAR system, for example, a window of the LIDAR system 100 such as the window 124, a window of the vehicle 110, for example, the front windshield in case of a behind the window installation of the LIDAR system 100, and/or the like. For example, based on the comparison between the computed values of the LIDAR performance indicator parameters and the corresponding reference values of a certain reference object 800, the executing processor may determine that the certain reference object 800 is partially visible, i.e., only some of its features are identifiable. In such case, the executing processor may determine and/or estimate that the partial detection may result from a blockage and/or defect in the window 124, for example, an accumulation of blocking agents, a scratch in the window, and/or the like.

In another example, degradation of the operation and/or performance of the LIDAR system 100 may result from one or more malfunctions of the LIDAR system 100 and/or components of the LIDAR system 100 operating outside their nominal operational specification, for example, a malfunction associated with a sensing unit of the LIDAR system 100 such as the sensing unit 106, for example, a malfunction in one or more sensors as the sensor 116. In another example, degradation of the operation and/or performance of the LIDAR system 100 may result from a malfunction associated with a projecting unit of the LIDAR system 100 such as the projecting unit 102, for example, a malfunction in one or more light sources such as the light source 112. In another example, degradation of the operation and/or performance of the LIDAR system 100 may result from a malfunction associated with a scanning unit of the LIDAR system 100 such as the scanning unit 104.

In another example, degradation of the operation and/or performance of the LIDAR system 100 may be caused by one or more environmental conditions present in the environment of the LIDAR system 100, for example, rain, snow, ice, hail, fog, smog, dust, insects, darkness, bright light, and/or the like.

Optionally, the executing processor may be further configured to identify a presence of one or more of the environmental conditions present in the environment of the LIDAR system 100 based on the comparison between the computed values and the corresponding reference values of one or more LIDAR performance indicator parameters.

In particular, the executing processor may identify presence of the environmental conditions based on comparison between the values of the LIDAR performance indicator parameter(s) computed based on the trace data, for example, a point cloud derived from the trace data and corresponding crowdsourced reference values, specifically crowdsourced reference values created in real-time based on data derived from trace data collected in real-time from a plurality of other LIDAR systems 100 located in significantly the same area as the LIDAR system 100.

As such, in case the values computed for the LIDAR performance indicator parameter(s) of the LIDAR system 100 are indicative of a degradation in the operation and/or performance of the LIDAR system 100 and the crowdsourced reference values are also indicative of degradation in the operation and/or performance of most and possibly all of the other LIDAR systems 100, the executing processor may estimate, and/or determine with high probability that the degradation is global and may result from (fast) changes in one or more of the characteristics of the reference object(s) 800 due to one or more environmental conditions present at the location of the LIDAR system 100. However, in case the values computed for the LIDAR performance indicator parameter(s) of the LIDAR system 100 are indicative of a degradation in the performance of the LIDAR system 100 while the crowdsourced reference values are indicative of normal performance of the other LIDAR systems 100, the executing processor may determine that the degradation is specific to the LIDAR system 100 and may result from one or more malfunctions, failures, and/or limitations specific to the LIDAR system 100.

As shown at 716, the executing processor may generate one or more alerts, indicative of the performance level of the LIDAR system 100, to one or more systems associated with the vehicle 110 on which the LIDAR system 100 is mounted, for example, an ADAS, an autonomous vehicle system, a safety system, and/or the like, designated vehicle control systems herein after.

As described in step 312 of the process 300, the executing processor may transmit the alert(s) via one or more communication channels, for example, the communication interface 114 in case the executing processor is the processor 118, and/or one or more communication channels of the host 210 in case the executing processor is the processor 218.

The alert may be indicative of the performance level of the LIDAR system 100. For example, the executing processor may generate one or more alerts indicative of an overall performance level of the LIDAR system 100. In another example, the executing processor may generate one or more alerts indicative of the performance level of each of one or more of the operational capabilities of the LIDAR system 100. Optionally, one or more alerts generated and/or transmitted by the executing processor may be indicative of the rate of degradation and/or decline in the performance level associated with one or more of the operational capabilities of the LIDAR system 100. One or more of the alerts may be further indicative of the time until one or more of the operational capabilities of the LIDAR system 100 is expected to cross one or more predefined threshold values.

As described in step 312 of the process 300, based on the information received from the executing processor via the alert(s), the vehicle control system(s), for example, the ADAS, the autonomous vehicle system, the safety system, and/or the like may take one or more actions, operations, and/or precautions according to the received alert(s) to encounter, compensate and/or mitigate the performance degradation in the LIDAR system 100.

The process 700 may be repeated continuously, periodically, and/or on command to identify evaluate and determine the performance level of the LIDAR system 100 over time, for example, while the vehicle 110 travels (drives) in one or more areas.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Moreover, aspects of the present disclosure may be embodied as a system, method and/or computer program product. As such, aspects of the disclosed embodiments may be provided in the form of an entirely hardware embodiment, an entirely software embodiment, or a combination thereof.

Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs and computer programs products based on the written description and disclosed methods are within the skill of an experienced developer. The various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations,
or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure.

It is expected that during the life of a patent maturing from this application many relevant systems, methods and computer programs will be developed and the scope of the terms LIDAR systems, light projection technologies, light sensing technologies, and scanning mechanisms, are intended to include all such new technologies a pion.

The terms “comprise”, “comprising”, “include”, “including”, “having” and their conjugates mean “including but not limited to”. These terms encompass the terms “consisting of” and “consisting essentially of” which mean that the composition or method may include additional ingredients and/or steps if the additional elements and/or steps do not materially alter the novel characteristics of the claimed composition or method.

As used herein the term “about” refers to f 5%.

Throughout this disclosure, various embodiments may be presented in a range format. Description in range format is merely for convenience and brevity and should not be construed as an inflexible limitation on the scope of the invention. Accordingly, the description of a range should be construed to include all the possible subranges as well as individual numerical values within that range.

It is appreciated that certain features of embodiments disclosed herein, which are, for clarity, described in the context of separate embodiments, may also be provided in combination in a single embodiment. Also, features described in combination in the context of a single embodiment may also be provided separately or in suitable sub-combinations in other embodiments described herein.

Publications, patents and patent applications referred to in this disclosure are to be incorporated into the specification in their entirety by reference as if each individual publication, patent or patent application was specifically and individually included in the disclosure. However, indication and/or identification of any such referenced document may not be construed as admission that the referenced document is available as prior art to embodiments disclosed hereon.

The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only.
with a true scope and spirit being indicated by the following claims and their full scope of equivalents.

1. A LIDAR system, comprising:
at least one light source configured to project light toward a field of view of the LIDAR system;
at least one sensor configured to receive light projected by the at least one light source and reflected from at least one object in the field of view; and
at least one processor configured to:
cause the at least one light source to project light towards at least a portion of the field of view in a plurality of scanning cycles;
receive, from the at least one sensor, reflection signals indicative of at least part of the projected light reflected from at least one object in the at least a portion of the field of view;
determine a variation in a level of at least one detection parameter in combination with a distance from the LIDAR system based on a statistical analysis of data derived from the reflection signals generated by the at least one sensor during the plurality of scanning cycles; and
identify volumetrically dispersed targets in the at least a portion of the field of view based on a dependency of the variation in the level of the at least one detection parameter on the distance, the volumetrically dispersed targets are indicative of at least one environmental condition.

2. The LIDAR system of claim 1, wherein the at least one environmental condition is a member of a group consisting of ice, snow, rain, hail, dust, and fog.

3. The LIDAR system of claim 1, wherein the variation in relation to the distance is induced by at least one characteristic of the at least one environmental condition, the at least one characteristic is a member of a group consisting of: a precipitation density, a particulate density, and an average particulate size.

4. The LIDAR system of claim 1, wherein the at least one detection parameter is a member of a group consisting of: a reflectivity level of at least one object identified in the at least a portion of the field of view, a detection range, a false detection rate, and a confidence level of detection.

5. (canceled)

6. The LIDAR system of claim 1, wherein the statistical analysis further comprises determining at least one change in a noise baseline over a range of distances relative to the LIDAR system, the at least one change in the noise baseline is indicative of at least one volumetric reflection condition induced by the at least one environmental condition.

7. The LIDAR system of claim 1, wherein the statistical analysis further comprises computing at least one light reflection distribution pattern typical to at least one volumetric reflection condition induced by the at least one environmental condition.

8. The LIDAR system of claim 1, further comprising applying a statistical analysis to analyze data extracted from a point cloud created based on the reflection signals to identify at least one point having no neighbor points and thus potentially indicative of the at least one environmental condition.

9. The LIDAR system of claim 1, further comprising estimating, based on the statistical analysis, a magnitude of impairment of at least one operational capability of the LIDAR system, the at least one operational capability is a member of a group consisting of a detection range, and a certainty of a determined distance to at least one object identified in the at least a portion of the field of view.

10. The LIDAR system of claim 1, further comprising predicting, based on the statistical analysis, an expected magnitude of impairment of at least one operational capability of the LIDAR system

11. The LIDAR system of claim 10, wherein the expected magnitude of impairment of the at least one operational capability is predicted based on at least one of:
analysis of information derived from the data compared with reference information retrieved from at least one lookup table; and
using at least one machine learning model trained to estimate magnitude of impairment of the at least one operational capability, the at least one machine learning model is trained using a training dataset comprising light reflection distribution patterns indicative of light reflection by the volumetrically dispersed targets.

12. (canceled)

13. The LIDAR system of claim 10, further comprising predicting, based on the statistical analysis, an expected fall of the at least one operational capability below a predetermined performance threshold.

14. The LIDAR system of claim 12, further comprising predicting, based on the statistical analysis, an amount of time until the at least one operational capability is expected to fall below the predetermined performance threshold.

15. The LIDAR system of claim 1, further comprising identifying the at least one environmental condition based on the statistical analysis combined with sensory data captured by at least one external sensor associated with a vehicle on which the LIDAR system is mounted, the at least one external sensor is a member of a group consisting of: an external light source, an ambient light sensor, and a precipitation sensor.

16. The LIDAR system of claim 1, further comprising identifying the at least one environmental condition and/or an impact of the at least one environmental condition on performance of the LIDAR system based on the statistical analysis combined with data associated with a location of a vehicle on which the LIDAR system is mounted, wherein the location of the vehicle is derived from at least one of a navigation system of the vehicle, and a map database, wherein the data associated with the location of the vehicle is received from at least one remote system.

17. The LIDAR system of claim 1, further comprising identifying, based on the statistical analysis, a presence of at least one blocking agent on a window associated with the LIDAR system, wherein the at least one blocking agents is a member of a group consisting of: ice, water droplets, smog, spray, dust, pollen, insects, mud, and bird droppings.

18. The LIDAR system of claim 16, further comprising predicting, based on the statistical analysis, an amount of time until at least one operational capability of the LIDAR system is expected to fall below a predetermined performance threshold based on an accumulation rate of the at least one blocking agent on the window.

19. The LIDAR system of claim 18, wherein the at least one processor is further configured to adjust the at least one alert to include at least one recommended operational restriction for a vehicle on which the LIDAR system is mounted.

20. A method of detecting environmental conditions based on statistical analysis of data captured by a LIDAR system, comprising:
causing at least one light source of a lidar system to project light towards at least a portion of a field of view of the lidar system in a plurality of scanning cycles;
receiving; reflection signals generated by at least one sensor of the lidar system in response to receiving of at least part of the projected light reflected from at least one object in the at least a portion of the field of view;
determining a variation in a level of at least one detection parameter in combination with a distance from the LIDAR system based on a statistical analysis of data derived from the reflection signals generated by the at least one sensor during the plurality of scanning cycles; and
identifying volumetrically dispersed targets in the at least a portion of the field of view based on a dependency of the variation in the level of the at least one detection parameter on the distance, the volumetrically dispersed targets are indicative of at least one environmental condition.

21-43. (canceled)

44. The LIDAR system of claim 1, wherein the volumetrically dispersed targets correspond to particulates associated with the at least one environmental condition.

45. The LIDAR system of claim 1, wherein the at least one processor is further configured to transmit at least one alert indicative of presence of the at least one environmental condition.
